(19) United States
(12) Patent Application Publication
(10) Pub. No.: US 2025/0039991 A1
(43) Pub. Date: Jan. 30, 2025

(54) COOKING APPLIANCE WITH BOTTOM HEATING ELEMENT AND TOP HEATING ELEMENT ADAPTED TO EACH OTHER

(71) Applicant: BSH Hausgeräte GmbH, Munich (DE)

(72) Inventors: Julien Adam, Lingolsheim (FR); Christophe Cadeau, Blaesheim (FR); Olivier Hoffmann, Molsheim (FR); Jean-Pierre Keusch, Ostheim (FR)

(21) Appl. No.: 18/716,523

(22) PCT Filed: Nov. 14, 2022
(86) PCT No.: PCT/EP2022/081769

§ 371 Date: Jun. 5, 2024

(30) Foreign Application Priority Data
Dec. 13, 2021 (EP) 21290087.2

(51) Int. Cl. H05B 1/02; F24C 7/06

(52) U.S. Cl. CPC H05B 1/0263; F24C 7/062; H05B 2203/003; H05B 2203/005

(57) ABSTRACT

A cooking appliance includes a housing and a muffle arranged in the housing and defining a cooking chamber. A first heating element is arranged outside the muffle in an intermediate space between the housing and the muffle and arranged as top-heat heating element in an upper intermediate space region between an upper wall of the muffle and an upper outer wall of the housing in substantially parallel spaced-apart relation thereto. A second heating element is arranged outside the muffle in an intermediate space between the housing and the muffle and arranged as bottom-heat heating element in a lower intermediate space region between a lower wall of the muffle and a lower outer wall of the housing in substantially parallel spaced-apart to the lower wall of the muffle. The first and second heating elements have same configuration in terms of an electrical heating element parameter and/or a geometric heating element parameter.

Aspects of the invention relate to a cooking appliance. The cooking appliance has a housing and a muffle which is arranged on the housing. The muffle defines a cooking chamber of the cooking appliance with walls.

Cooking appliances, for example an oven or a microwave cooking appliance or a steam cooking appliance, have a muffle made of metal. The walls are designed to be as thin as possible in order to be able to keep the weight of the muffle to a minimum. In conventional cooking appliances it is provided that heating elements or heating bodies can be arranged, on the one hand, inside the cooking chamber as can be the case in top-heat heating bodies and/or grill heating bodies, for example. On the other hand, such heating elements can also be arranged outside the muffle as can be the case in bottom-heat heating bodies, for example. In heating elements which are resistance heating bodies, a large amount of heat is also transmitted directly to the walls of the muffle in this context. This can also result in deformations of the muffle.

Moreover, in known cooking appliances it is also the case that top-heat heating bodies can also be arranged outside the cooking chamber. For example, this is disclosed in DE 10 2010 039 342 A1. A cooking appliance is also disclosed in US 2019/0045590 A1 which has a heating body which is constructed from a plurality of separate heating units as the top-heat heating body.

In such cooking appliances in which a top-heat heating body is arranged outside the muffle, and in particular above a top wall of the muffle, insulating material is also arranged in an intermediate space between the top wall of the muffle and a top wall of a housing of the cooking appliance. A further cooking appliance with a specific top-heat heating body is also disclosed in DE 10 2015 225 928 A1.

It is the object of the present invention to provide a cooking appliance which is improved relative to thermal management, in particular the protection of specific components of the cooking appliance during the operation of a heating element of the cooking appliance.

This object is achieved by a cooking appliance which has the features as claimed in claim 1.

An independent aspect of the invention relates to a cooking appliance. The cooking appliance has a housing. This housing can also be denoted as the outer housing. The cooking appliance also has a muffle. This muffle is a component which is separate from the housing. The muffle is arranged in the housing. The muffle defines a cooking chamber of the cooking appliance with walls. In particular, this cooking chamber is directly defined at least in some regions by the walls of the muffle.

In particular, the cooking appliance has at least one heating element. The heating element is configured, in particular, in a strand-like or rod-like manner and repeatedly bent. In one exemplary embodiment, the at least one heating element is arranged outside the muffle. In particular, the heating element is arranged in an intermediate space between the housing and the muffle. In particular, the heating element is arranged in this intermediate space, spaced apart from a wall of the muffle facing the heating element and adjacent thereto. The wall is the wall of the muffle closest to the heating element.

In one exemplary embodiment, the cooking appliance has a distancing unit. This distancing unit is configured and provided, as intended, to position the heating element in this intermediate space at a defined or discretely predetermined spacing from this wall of the muffle. Thus a heating element is arranged outside the cooking chamber, said heating element also being positioned in a defined manner in the intermediate space without contact with the outer face of the wall of the muffle. As a result, the position of the heating element relative to this wall can be set and predetermined in a particularly exact manner. Specifically when due to its strand-like and repeatedly wound shape the heating element extends, in particular, in a surface which is oriented parallel to the wall of the muffle, a very exact and uniform spacing from this wall of the muffle can be set for the entire heating element. The surface which is oriented parallel to this wall of the muffle, in particular, is that surface in which the heating element extends in a two-dimensional manner with its strand-like and wound shape. This means that the heating element is arranged to run at least 80%, in particular at least 90%, in this extension surface. This also results in the spacing from the wall of the muffle being kept constant or substantially constant during the operation of the heating element. In particular, this distancing unit is arranged between the heating element and the wall. This enables the direct coupling between the distancing unit and the heating element and the muffle. This also achieves very precise positioning and mechanically stable fastening.

In such a distancing unit, it is achieved specifically for those heating elements which are arranged outside the muffle to set a highly exact positioning relative to this wall in a more accurate manner. Thus, in particular when the heating element is a resistance heating body, the heat discharged from this heating element can also be transmitted to the wall more uniformly and also over the entire surface with a specific heat profile. The heating of this wall of the muffle is improved thereby, so that in turn the heat discharged from the wall into the cooking chamber is improved. This is because here the heat can be more uniformly discharged from the wall into the cooking chamber. Undesirable heat hotspots, or those which have been displaced in terms of position, can be avoided thereby in an improved manner.

This position can also be permanently set in a precise manner by such a distancing unit. In particular, even when the heating element is in operation and also discharges a large amount of heat, this enables the position to be kept very uniform or with small tolerances relative to the wall which can also potentially be deformed.

In one exemplary embodiment, the distancing unit has distancing rods. These distancing rods are oriented with their longitudinal axes protruding at least in some portions from the surface which is spanned by the main surface of the heating element, in terms of size. In this case, as in the other examples, this surface can also be planar or curved. The rods are thus primarily not oriented in the plane or do not extend primarily in the plane in which the heating element mainly extends. On the one hand, a very finely structured distancing unit can be created by the distancing rods. Thus the distancing unit can be designed to be space-saving and also reduced in weight. On the other hand, the rods provide correspondingly mechanically stable elements which can maintain this desired defined distancing of the heating element from the adjacent wall of the muffle. In this regard, the rods are very insensitive to the heat which is produced, so that undesired deformations of the rods can be avoided.

Moreover, particularly exact mechanical couplings with other components of the cooking appliance can be also achieved by such distancing rods. As a result, mechanically stable connections are produced. Thus the distancing unit per se can also be arranged in a manner in which it is precisely located and fixed in position in the cooking appliance. The corresponding length can also be set in a very exact manner by the orientation of the distancing rods. This also results in a very exact setting of the spacing from the heating element to the wall of the muffle.

In one exemplary embodiment, at least one distancing rod has a bent-back portion at one end which is remote from the heating element. This bent-back portion is formed as a positioning coupling part.

In one exemplary embodiment, the bent-back portion represents, in particular, a freely protruding end piece of the distancing rod.

In one exemplary embodiment, the distancing unit is positioned with this bent-back portion on a side of a counter-coupling element of the cooking appliance facing the heating element. In particular, this positioning is provided in relation to a distance-setting coupling. In particular, this bent-back portion is positioned directly on this facing side of a counter-coupling element. Although a rod is used here as an element of the distancing unit, in one exemplary embodiment it is possible to achieve by this bent-back portion not only a point contact but a linear contact with this facing side of the counter-coupling element. This enables a mechanically stable coupling. A coupling which is mechanically more stable and an improved positional fixing are also achieved thereby.

In one exemplary embodiment, the bent-back portion is arranged at an angle of between 80° and 100°, in particular between 85° and 95°, relative to the remaining region of this distancing rod which adjoins thereto at the rear. Such an angle of the distancing rod also permits in turn a very stable and uniform positioning on this facing side of the counter-coupling element.

In one exemplary embodiment, at least one distancing rod has a bent-back portion at one end which is remote from the heating element. In the exemplary embodiment, this bent-back portion is formed as a rear-engaging coupling part. The distancing unit in the mounted state bears with this rear-engaging coupling part against a side of the counter-coupling element of the cooking appliance remote from and engaging to the rear of the heating element. This mechanical coupling is also provided, in particular directly, for the distance-setting coupling. A mechanically stable and very positionally precise attachment of the distancing unit to the counter-coupling element is made possible by such a rear-engaging coupling. A very exact positional securing is assisted thereby.

This positional fixing and positionally precise arrangement of the distancing unit on the counter-coupling element is particularly advantageous when both a distancing rod with a rear-engaging coupling part and a further distancing rod with a positioning coupling part are implemented. This is because the counter-coupling element can be mechanically contacted practically from both sides with one respectively corresponding bent-back portion of the distancing rods. A particularly stable mechanical connection is achieved thereby. In particular, this also enables a clamping or clamped mounting of the distancing unit on the counter-coupling element to be formed by these two bent-back portions. As a result, the position securing and the mechanically stable attachment are particularly advantageously achieved. In particular, if deformations and/or positional changes were potentially to occur due to the large amount of heat during the operation of the heating element, this mechanical connection is particularly advantageous in order to permit or to counteract corresponding deformations and positional changes, if at all minimal.

In one exemplary embodiment, the counter-coupling element has a continuous recess which is open, in particular, on the edge side. The distancing rod engages through this recess with a rod part formed upstream of the bent-back portion, so that the rear-engaging coupling part adjoining the rod part is arranged on the side of the counter-coupling element remote from the heating element. The compact and mechanically stable construction of this mechanical connection is also assisted thereby. The rod part which adjoins, in particular, the rear-engaging coupling part, is thus also arranged in a mechanically stabilized manner. In particular, a greater protection is also achieved thereby against slippage relative to the counter-coupling element. The positionally fixed arrangement of the distancing unit on the counter-coupling element is further assisted thereby.

In one exemplary embodiment, it is provided that the counter-coupling element is arranged, in particular clamped, between the positioning coupling part and the rear-engaging coupling part. The advantages which can be achieved thereby have already been explained above. In particular, a positional fixing is achieved in at least one, in particular at least two, and preferably all three spatial directions.

In one exemplary embodiment, the distancing unit is configured for the positional fixing of the heating element to at least one counter-coupling element of the cooking appliance in at least two, in particular all three, spatial directions. In particular, the distancing unit is coupled directly to the counter-coupling element. The mechanically stable arrangement is also advantageously assisted thereby.

In one exemplary embodiment, the distancing unit has a height which is greater by a multiple than a thickness of a strand of the heating element in a direction perpendicular to the surface which is spanned by the main surface of the heating element, in terms of size. As a result, the distancing unit can be flexibly positioned in terms of location, since due to the corresponding height a sufficient spacing can still always be present between the heating element and the wall of the muffle which is arranged adjacent to the heating element and, in particular, extends parallel thereto. Thus the distancing unit can also be arranged directly on the elements of the cooking appliance which are not this wall of the muffle, from which the heating element is to be arranged spaced apart.

In one exemplary embodiment, the heating element is arranged by the distancing unit at a spacing from the outer face of the adjacent wall which is between 0.8 times and 1.5 times the thickness, in particular the diameter, of a strand of the heating element. In one exemplary embodiment, it can be provided that the heating element is arranged by the distancing unit at a spacing from the outer face of the adjacent wall which is between 0.3 mm and 0.7 mm, in particular between 0.3 mm and 0.5 mm. Such a spacing setting enables the heating element and the wall always to be arranged without contact with one another, even when the heating element is in operation. However, this spacing is also specified such that a particularly high level of heat transfer of the heat generated by the heating element can take place to the wall. This achieves a very advantageous energy transfer and thus a very high efficiency relative to the heating of this wall of the muffle.

Moreover, a very compact construction can still be achieved, in particular when considered over the height of the cooking appliance. This is the case, in particular, when the heating element is arranged in an intermediate space between the top wall of the muffle and the top wall of the housing, when viewed in the height direction.

In one exemplary embodiment, the cooking appliance has position securing elements which are connected in each case directly to the plurality of strand portions of the heating elements, so that these strand portions are fixed in position relative to one another. This prevents an undesired deformation of the heating element and, in particular, an undesired relative movement of the strand portions relative to one another. The shape of the heating element is particularly advantageously maintained thereby.

In one exemplary embodiment, the position securing elements are formed as position securing rods. In one exemplary embodiment, in each case a distancing rod of the distancing unit is arranged, in particular, at opposing ends of a position securing rod. In particular, the distancing rod is arranged at an angled orientation to the position securing rod on the end side. Thus a multifunctional component is provided by such a position securing rod. On the one hand, the position securing rod holds the strand portions of the heating element in position with one another and, on the other hand, it is formed as a direct receiving part for a distancing rod.

In one exemplary embodiment, it can be provided that a position securing rod and a distancing rod are formed in one piece. For example, this can be a metal rod. In one exemplary embodiment, the distancing rod is arranged with its longitudinal axis at an angle of between 85° and 95° to the longitudinal axis of the position securing rod.

In one exemplary embodiment, a position securing rod and two distancing rods are configured in one piece. In particular, they form together a U-shaped carrier and positioning rod. As a result, such a complete rod can also be arranged mechanically in the manner of a clamp or as a clamped part on opposing regions of a counter-coupling element, in particular arranged thereon in a clamped manner. The mounting is further improved thereby.

In particular, a plurality of such U-shaped carrier and positioning rods are arranged. Thus a carrying frame can also be formed from a plurality of such carrier and positioning rods.

In one exemplary embodiment, the distancing unit is coupled to at least one counter-coupling element of the cooking appliance for positional fixing. In one exemplary embodiment, the counter-coupling element is formed as a flange protruding on an outer face of the muffle and from the outer face. In one exemplary embodiment, a strip-shaped projection is formed which protrudes to the side, in particular in the width direction of the cooking appliance, and which represents this counter-coupling element. It can be provided that such a flange extends over the entire depth of a wall of the muffle, when viewed in the depth direction of the cooking appliance. This flange can be configured without interruption. As a result, the counter-coupling element is inherently stable and rigid. This enables the direct mechanical coupling to a distancing rod, in particular a plurality of distancing rods, in particular with a rear-engaging coupling part and a positioning coupling part, in a particularly stable manner.

In one exemplary embodiment, this flange is arranged offset downwardly relative to a top wall of the muffle which forms the wall adjacent to the heating element, when viewed in the height direction of the cooking appliance. In particular, this flange is arranged on an outer face of at least one side wall of the muffle. In one exemplary embodiment, this flange is arranged offset downwardly relative to a trough ceiling of the top wall of the muffle which forms the wall adjacent to the heating element, when viewed in the height direction of the cooking appliance. In particular, this flange is arranged on an outer face of a trough collar of a trough-shaped top wall of the muffle. As a result, the bearing point or the coupling point between a distancing rod and the counter-coupling element is offset downwardly relative to this trough ceiling, when viewed in the height direction, but is itself nevertheless formed on the top wall. The mechanical coupling and the positionally fixed arrangement of the distancing unit are also improved thereby. Considered per se, the top wall can then also be individually produced and shaped, and have the flange which is configured to be integrated therewith.

In one exemplary embodiment, the heating element is a top-heat and/or grill heating body of the cooking appliance. It is particularly advantageous if the heating element is a resistance heating element. Such heating elements generate the thermal energy by the electrical energy supplied. Here temperatures of the heating element can be greater than 650° C., in particular greater than 700° C., and optionally temperatures of up to or even above 750° C. are present. The invention is particularly advantageous specifically in such heating elements which are resistance heating elements. This is because when such a heating element is positioned outside the cooking chamber, such a heat has to be generated that the cooking chamber can also be correspondingly heated up indirectly by the muffle wall. Thus due to the heating element arranged outside the cooking chamber, a corresponding high level of thermal energy and thus a corresponding heat of the heating element also act directly on the adjacent wall of the muffle. Specifically with a top-heat and/or grill heating body, for example, the top wall of the muffle is correspondingly heated as desired and as required, in order then to be able to discharge the corresponding heat in turn into the cooking chamber. In such a design, therefore, it is particularly advantageous to set an arrangement of such a resistance heating element spaced apart from the adjacent wall. This is, in particular, so as not to generate any undesired thermal effects, in particular undesired deformations, in particular locally on the muffle due to the strand portions positioned there. Moreover, in such arrangements it is also particularly advantageous if the heating element and the muffle are also positioned very exactly in relation to one another and also remain so during operation.

A further independent aspect of the invention relates to a cooking appliance. The cooking appliance has a housing. This housing can also be denoted as an outer housing. The cooking appliance also has a muffle. This muffle is a component which is separate from the housing. The muffle is arranged in the housing. The muffle defines a cooking chamber of the cooking appliance with walls. In particular, this cooking chamber is directly defined in at least some regions by the walls of the muffle.

In particular, the cooking appliance has at least one heating element. The heating element is configured, in particular, in a strand-like or rod-like manner and repeatedly bent. In one exemplary embodiment, the at least one heating element is arranged outside the muffle. In particular, the heating element is arranged in an intermediate space between the housing and the muffle. In particular, the heating element is arranged spaced apart from a wall of the muffle facing the heating element and adjacent thereto in this intermediate space. The wall is the wall of the muffle closest to the heating element.

A thermal shielding unit of the cooking appliance is arranged in the intermediate space. The heating element is thermally shielded thereby relative to the housing in terms of function and as intended. In one exemplary embodiment, the material of this thermal shielding element is characterized by a melting point which is higher than the maximum operating temperature of the heating element. This thermal shielding unit has at least a material which has a temperature value as a melting point which is higher than the maximum operating temperature of the heating element which can be set. This particularly advantageously enables such a heating element which is located outside the cooking chamber, and which in particular is a resistance heating element, to be particularly advantageously thermally insulated relative to the housing. At very high temperatures which can occur during the operation of the heating element, an advantageous thermal shielding is thus achieved between the heating element and the housing. In particular, a melting of the material during the operation of the heating element can be avoided by this specific choice of material of the thermal shielding unit. This is particularly advantageous, in particular, when the thermal shielding unit is arranged at least in some regions in direct contact with the heating element. The cooking appliance is implemented in a particularly compact manner by such a construction, at least in the height direction, but on the other hand the thermal shielding unit cannot be undesirably impaired at these high temperatures of a resistance heating body.

In one exemplary embodiment, the material of the thermal shielding unit is at least partially rock wool. Preferably, the thermal shielding unit is formed entirely from rock wool. This material has a particularly high melting point. As a result, it can be particularly advantageously used when the heating element is a resistance heating body which can have operating temperatures of over 700° C. during operation. In particular, the material is needled rock wool. In particular, it comprises an inorganic binder. In particular, the material has a density of between 80 g/m³ and 120 g/m³.

In one exemplary embodiment, the thermal shielding unit is a mat made of fibrous material. This mat is preferably resiliently deformable. As a result, it can be adapted particularly advantageously to the installation conditions. Not least, it can be installed in a particularly advantageous manner in direct contact with the heating element. In this context, the mat can be shaped in a variety of ways.

In one exemplary embodiment, the thermal shielding unit has a thickness of between 12 mm and 18 mm, in particular between 13 mm and 17 mm, in particular 15 mm. As a result, the shielding unit can be designed to be relatively thin. On the one hand, installation space can also be saved thereby and, on the other hand, a sufficient thermal insulation can still be possible without the thermal shielding unit being impaired in terms of its function by the heat of the heating element during operation. Preferably, this thickness is provided in an upper intermediate space region in which a top-heat and/or grill heating body is arranged as the heating element. A further thermal insulating unit, for example glass wool, can also be arranged here. This results in a multi-layered composite made of different thermally insulating materials.

In one exemplary embodiment, the thermal shielding unit has a thickness of between 35 mm and 45 mm, in particular between 38 mm and 42 mm, in particular 40 mm. Preferably, this thickness is provided in a lower intermediate space region in which a bottom-heat heating body is arranged as the heating element. This results in the possibility of arranging only this thermal shielding unit.

In one exemplary embodiment, the thermal shielding unit is in direct contact with the heating element, as already explained above. This can be implemented when the above-mentioned conditions are present, namely the higher melting point of the material of the shielding unit in comparison with the maximum operating temperature of the heating element.

In one exemplary embodiment, the thermal shielding unit is arranged only on the side of the heating element remote from the muffle, in the intermediate space between the heating element and the housing. In this context, it is also essential that the heating element arranged outside the cooking chamber can discharge maximum thermal energy to the adjacent wall of the muffle. Thermal insulation would negatively influence the efficiency of the heating element here. On the other hand, the region of the heating element which is remote from the muffle and is located between the heating element and the housing is intended to be thermally insulated in the best possible manner. This also means that the housing is not undesirably heated and no undesired deformations result therefrom.

In one exemplary embodiment, when viewed two-dimensionally, the heating element is located parallel to the closest wall of the muffle which is arranged adjacent to the heating element and in particular extends at least substantially, in particular entirely, two-dimensionally in a surface which is parallel to the main extension surface of the heating element.

In one exemplary embodiment, the thermal shielding unit comprises a metal plate or a metal mesh. This can be designed to be particularly thin so that a particularly compact construction is implemented here. In one exemplary embodiment, an infrared reflector can also be implemented with a metal plate. On the other hand, a further thermal insulating element which is present in one exemplary embodiment and which is arranged in the intermediate space between the heating element and the housing, in particular the metal plate and the housing, can be protected with a metal plate. Thus in one exemplary embodiment, such a metal plate or a metal mesh is also suitable for being able to be used as such a thermal shielding unit.

In one exemplary embodiment, at least one thermal insulating unit which is separate from the thermal shielding unit and/or different in at least one material parameter is arranged in the intermediate space between the wall of the muffle and the wall of the housing.

Generally and not only in the exemplary embodiment mentioned here, the wall of the muffle, which respectively is to be taken into consideration, and the wall of the housing are arranged in parallel surfaces or substantially parallel surfaces to one another. Thus in each case consideration is given to an intermediate space or an intermediate space region of the intermediate space which is defined by parallel and spaced-apart walls and namely, on the one hand, the wall of the muffle and, on the other hand, the wall of the housing. These walls extend, in particular, parallel to one another.

This thermal insulating unit is able to achieve in turn an advantageous thermal insulating effect relative to the housing. In one exemplary embodiment, this thermal insulating unit is also arranged only in that region of the intermediate space which is located between the heating element and the wall of the housing. In particular, the thermal insulating element is arranged between the thermal shielding unit and the wall of the housing. Due to the thermal shielding unit, this additional thermal insulating element can be selected in terms of function and in terms of material such that it has a lower melting point than the maximum operating temperature of the heating element. This is because this thermal insulating element is separated from the heating element by the interposed thermal shielding unit. Thus a simpler and optionally more cost-effective thermal insulating material can be used for this thermal insulating unit.

In one exemplary embodiment, it can be provided that the thermal insulating unit is a mat made of fibrous material. For example, it can comprise glass wool or be entirely made of glass wool.

In one exemplary embodiment, the thermal insulating unit is thicker than the thermal shielding element or the thermal shielding unit. The material of the thermal shielding unit, in particular, is different, in particular entirely different, from the material of the thermal insulating unit.

In one exemplary embodiment, the thermal shielding unit and the insulating unit are separate components. However, they can be arranged so as to bear directly against one another in the intermediate space.

As already mentioned above, in one exemplary embodiment the maximum operating temperature of the heating element is greater than 500° C., in particular greater than 700° C., in particular between 700° C. and 800° C.

In particular, the heating element is a resistance heating element. In one exemplary embodiment, the heating element is shaped in a strand-like manner and repeatedly bent. In particular, the heating element is a top-heat and/or grill heating body. The heating element is thus arranged in an intermediate space between a top wall of the muffle and a top wall of the housing.

A further independent aspect of the invention relates to a cooking appliance. The cooking appliance has a housing. This housing can also be denoted as the outer housing. Moreover, the cooking appliance also has a muffle. This muffle is a component of the cooking appliance which is separate from the housing. The muffle is arranged in the housing. The muffle has walls, with which it defines a cooking chamber of the cooking appliance. In particular, the cooking chamber is directly defined by the walls of the muffle. Moreover, the cooking appliance has at least one, in particular strand-like or rod-like, heating element which is repeatedly bent in a single plane. This heating element is arranged outside the muffle in an intermediate space between the housing and the muffle. The heating element is arranged only in an intermediate space region of the intermediate space which is formed between only one wall of the muffle and only one outer wall of the housing which is spaced apart therefrom and arranged at least substantially parallel thereto. In one exemplary embodiment, the heating element is formed or extends substantially only in a surface which is located between only one wall of the muffle and only one outer wall of the housing. In one exemplary embodiment, the heating element has a first strand-like heating sub-element which is configured to be repeatedly bent in a single extension surface. In one exemplary embodiment, the heating element has a second strand-like and, in particular, repeatedly bent heating sub-element in a single extension surface. The two heating sub-elements are separate parts of the heating element. When viewed in a projection plane, the one heating sub-element is surrounded by the other heating sub-element. The windings of the one heating sub-element are spaced apart around the other heating sub-element. The heating sub-elements can respectively be operated independently of one another in possible operating modes, and can be operated jointly in a further operating mode. This means that the cooking appliance has at least three different operating modes relative to the modes of operation of the heating element. In a first operating mode, for example, the first heating sub-element can be operated and thus activated. The second heating sub-element is then deactivated. In a second operating mode, the first heating sub-element can be deactivated and the second heating sub-element operated or activated. In a third operating mode, both the first heating sub-element and at the same time the second heating sub-element can be activated.

In one exemplary embodiment, at least one of the heating sub-elements has a maximum possible heat output which is greater than or equal to 2 kW. Additionally or alternatively, in one exemplary embodiment it can be provided that in the further operating mode, in which they are operated at the same time, the two heating sub-elements have a total maximum heat output of greater than or equal to 3 kW. In this exemplary embodiment of the cooking appliance, with a heating element arranged outside the cooking chamber, it is thus possible that this heating element is arranged compactly and locally but on the other hand has at least two separate heating sub-elements which are also arranged specifically relative to one another. Specifically these at least two heating sub-elements of a heating element are provided. In principle, a more flexible and more variable mode of operation of the heating element is made possible thereby. This is because due to the specific arrangement of the heating sub-elements to one another and the quite specific heat output values, in particular this permits at least one heating sub-element with a relatively high maximum heat output and also a relatively high total heat output, such a heating element can also be used particularly advantageously as a grill heating body for a cooking appliance. Thus the possibility for the use of a heating element are significantly increased by such high heat outputs which are provided. While such a heating element is fixed locally in this regard, it can be used in a wide variety of ways in the cooking appliance due to this number of components, the arrangement thereof to one another and the specific heat output values. A compact construction with a reduced number of components can also be permitted thereby.

In one exemplary embodiment, a maximum heat output of a heating sub-element is less than the maximum heat output of the other heating sub-element. Thus two identical heating sub-elements are not used. This is advantageous, on the one hand, so as not to find that the entire system of the heating element is oversized but, on the other hand, to find that one of the two heating sub-elements has a relatively high maximum heat output, when considered per se. This is the case both in general and also in comparison with the at least one other heating sub-element of the heating element. Thus the purpose of use of such a heating element can be extensive and a wide variety of modes of operation can be permitted. Thus a relatively high maximum heat output of the heating element can be already provided with one of the two heating sub-elements. If it necessary that this maximum heat output has to be greater for a preparation process for a food to be cooked, the further operating mode can be implemented by the at least two heating sub-elements of the heating element being operated at the same time. If, on the other hand, potentially only a lower heat output is required, however, it is possible to operate only that heating sub-element which has the lower maximum heat output in comparison with the other heating element. In principle, this enables a very energy efficient operation in all operating modes of the heating element. This is because it is always possible, on a customized basis, to select for the operation a configuration of the heating sub-elements which provides the required heat output according to requirements and in an energy-saving manner.

In one exemplary embodiment, the maximum heat output of the heating sub-element with the greater maximum heat output is greater by at least 50%, in particular at least 60%, in particular a maximum of 90%, than the maximum heat output of the heating sub-element with the lower heat output. This is a very advantageous exemplary embodiment since the maximum heat outputs not only differ minimally from one another, but differ at least by this half percentage value. Thus the above-mentioned advantages are met to a particular degree.

In one exemplary embodiment, the maximum heat output of the heating sub-element with the lower maximum heat output is between 1.0 kW and 1.5 kW. In particular, this maximum heat output is between 1.1 kW and 1.3 kW, in particular 1.2 kW. This range of values makes it possible to use the heating sub-element solely for a quite specific and a relatively large number of cooking processes. This maximum heat output is thus not sufficiently low that this one heating sub-element would only be sufficient for exceptional cases.

In one exemplary embodiment, the maximum heat output of the heating sub-element with the greater maximum heat output is between 2.0 kW and 2.5 kW. In particular, this maximum heat output is between 2.1 kW and 2.3 kW. This provides a heating sub-element which has a relatively high maximum heat output per se. Thus it is possible to carry out a wide variety of preparation processes in which higher heat outputs are required, solely with this one heating sub-element.

As already mentioned above, the further operating mode is enabled when this heat output of a heating sub-element is no longer sufficient on its own to carry out a preparation process. It is advantageously provided here that the maximum total heat output of the heating element is between 3.0 kW and 4.0 kW, in particular between 3.2 kW and 3.5 kW, in particular 3.4 kW. Then the heating element can also be used as a grill heating body of the cooking appliance.

In one exemplary embodiment, when viewed in a projection plane, the first heating sub-element surrounds the second heating sub-element, wherein the first heating sub-element has a greater maximum heat output than the second heating sub-element. In this configuration, when viewed in a projection plane, the first heating sub-element with the greater maximum heat output is the outer heating sub-element. The greater heat output is more uniformly distributed thereby over a larger volume space. The discharge source is thus not as locally concentrated as in the second inner heating sub-element in this projection plane. Thus such an arrangement is specifically advantageous for the greater heat outputs for a discharge which is more uniform or homogenous, as required.

In this context, the respective geometry or the strand path of the individual heating sub-elements is particularly advantageous. On the one hand, considered per se, this is in order to bring about a very customized and uniform discharge of the heat output and, on the other hand, in order to be able to bring about by cooperation an individual discharge of the heat output which is very advantageous and which is as local as possible.

In one exemplary embodiment, the strand shape of the entire strand of a heating sub-element, in particular the inner heating sub-element in the projection plane, has an asymmetrical H-shape. This shape produces the aforementioned advantages, on the one hand, considered per se and on the other hand in combination with the other heating sub-element.

In one exemplary embodiment, the strand shape of the entire strand of a heating sub-element, in particular the outer heating sub-element in the projection plane, is formed with two L-shaped strand portions which are formed by the strand paths as hollow L-shapes. In particular these two L-shapes, in particular hollow L-shapes, are arranged mirror-symmetrically to one another relative to a central axis of symmetry of the heating element. In particular, this axis of symmetry is parallel to the electrical connection end pieces of the two heating sub-elements. This specific shape of the one heating sub-element additionally assists the above-mentioned advantages.

In one exemplary embodiment, when viewed in the extension surface, the heating element has a greater surface density on the edge side than in the middle. In this regard, the heating sub-elements are also arranged corresponding to one another, in particular adapted thereto by their specific strand paths.

With the larger surface density on the edge side, such a configuration can achieve an improved distribution and discharge of this heat output, in particular with very high heat outputs. This enables an improved preparation result.

In one exemplary embodiment, a heating element of this cooking appliance, as set forth above, and optionally as can be developed by an advantageous exemplary embodiment, is a top-heat and/or grill heating body of the cooking appliance. Additionally or alternatively, in a further exemplary embodiment a heating element of the cooking appliance can also be a bottom-heat heating body, as is formed according to the above-mentioned aspect or is developed according to an advantageous exemplary embodiment. Thus in one exemplary embodiment, it is possible that only one top-heat and/or grill heating body is correspondingly designed. In a further exemplary embodiment, only one bottom-heat heating body of the cooking appliance can have a corresponding design. It is possible in a further exemplary embodiment, however, that both a top-heat and/or grill heating body and a bottom-heat heating body of the cooking appliance are correspondingly formed. In such an exemplary embodiment, it can also be possible that the top-heat and/or grill heating body and the bottom-heat heating body are the same. This can relate to both geometric aspects and/or operating parameters or physical parameters of these heating bodies.

In a further exemplary embodiment, at least one temperature sensor of the cooking appliance can be arranged adjacent to both heating sub-elements. In one exemplary embodiment, in the further operating mode, the temperature of the entire heating element can be detected thereby. On the other hand, in a further operating mode in which only one of the two heating sub-elements is activated, the temperature of only this activated heating sub-element can be detected. In particular, the temperature of the adjacent wall of the muffle is detected by the temperature sensor. Due to the position of the temperature sensor at the same or substantially the same spacing from two strand portions of the heating sub-elements, the temperature of the wall can be locally detected in all operating modes of the heating element at the same point. Due to this position of the temperature sensor closest to the two heating sub-elements, the temperature detection is particularly precise in all operating modes of the heating element. Due to this specific exposed position of a temperature sensor, the respective temperature of one or more heating sub-elements can be detected as a function of the respective operating mode. Thus it is also made possible that the temperature of the respective active heating sub-element can be detected precisely in different operating modes practically with a single temperature sensor. Relative thereto it is also possible to provide an array of temperature sensors with a reduced number of components. Thus, for example, only one temperature sensor is used in order to detect the temperature of the respective active heating sub-element in the different operating modes of the heating element.

It is also possible in this context to provide a plurality of temperature sensors which are arranged in a correspondingly exposed manner. These temperature sensors can respectively detect the temperature of the at least one activated heating sub-element as a function of the respectively provided operating mode.

A further independent aspect of the invention relates to a cooking appliance. This cooking appliance has a housing. The housing can also be denoted as the outer housing. The cooking appliance also has a muffle. This muffle is a component of the cooking appliance which is separate from the housing. The muffle is arranged in the housing. The muffle defines a cooking chamber of the cooking appliance with walls. In particular, the muffle directly defines the cooking chamber with walls. The cooking appliance also has at least one, in particular strand-like or rod-like, heating element which is repeatedly bent, in particular in a single main extension surface.

The heating element primarily extends with its dimensions in this main extension surface, and this applies to all aspects and exemplary embodiments of the invention.

This heating element is arranged outside the muffle in an intermediate space between the housing and the muffle. This heating element is arranged only in an intermediate space region of the intermediate space which is formed between only one wall of the muffle and only one outer wall of the housing which is spaced apart therefrom and arranged at least substantially parallel thereto. The heating element has a first, in particular strand-like or rod-like, heating sub-element which is repeatedly bent in a single main extension surface. The heating element also has a separate second, in particular strand-like or rod-like, heating sub-element which is different therefrom and repeatedly bent in only a single main extension surface. When viewed in a projection plane which runs parallel to the main extension surface and in which the heating element extends two-dimensionally, the one heating sub-element is surrounded by the other heating sub-element. One heating sub-element can be operated independently of the other heating sub-element in possible operating modes of the heating element. These at least two heating sub-elements of the heating element can be operated jointly and thus at the same time in a further operating mode of the heating element. The at least three different operating modes can also be present here, as have already been described above.

The cooking appliance preferably has at least one temperature sensor for detecting the temperature of the heating element. The temperature sensor is arranged in the intermediate space region and is arranged adjacent to both heating sub-elements and between the heating sub-elements. This is accordingly the case, in particular, when viewed in the projection plane. The cooking appliance has, in particular, at least one temperature sensor at least for detecting the temperature of the wall of the muffle. The temperature sensor is arranged in the intermediate space region and adjacent to and between both heating sub-elements. In each case, the temperature of the wall of the muffle can be detected with the one temperature sensor in the operating modes of the heating element, in particular at the same point.

In one exemplary embodiment, the temperature sensor is at a spacing from the first heating sub-element which is the same or substantially the same as the spacing of the temperature sensor from the second heating sub-element. This also applies, in particular, in the projection plane. A difference in the spacing of less than 10% of one of the two spacings is preferred in this regard. In particular, a deviation of less than or equal to 10% of the smaller of the two spacings is possible here. In particular, this is measured at the point of the temperature sensor which, when viewed along a straight line, is at the shortest spacing from the respectively adjacent heating sub-element. Such a positioning of a temperature sensor makes it possible to detect the current temperature of the wall particularly precisely. In particular, this information is not only able to be transmitted to a control unit of the cooking appliance. A corresponding evaluation of the information obtained by the sensor can be carried out thereby. In particular, an adapted mode of operation of at least the heating element can be implemented. In particular, a control and/or regulation can take place here.

In one exemplary embodiment, this temperature sensor is arranged so as to bear directly against an outer face of the muffle. The temperature sensor can be formed in a tubular manner at least in some regions.

It can be provided that the temperature sensor is a PT sensor. The temperature sensor can be, in particular, a PT500 or a PT1000.

In one exemplary embodiment, an electrical supply line to the sensor is arranged in a protected manner relative to the heating element. This can be positional and/or by a corresponding heat-resistant sheathing of the cable or the electrical line. For example, it can also be provided that this electrical line is routed entirely through a thermal insulating unit and/or through a thermal shielding unit which is arranged in the intermediate space region. This also enables an advantageous thermal insulation of this cable of the sensor.

A further independent aspect of the invention relates to a cooking appliance. The cooking appliance has a housing. This housing can also be denoted as the outer housing. Moreover, the cooking appliance also has a muffle. This muffle is a component of the cooking appliance which is separate from the housing. The muffle is arranged in the housing. The muffle defines a cooking chamber of the cooking appliance with walls. In particular, the muffle directly defines the cooking chamber with walls. The muffle has a top wall, a bottom wall, a rear wall and side walls. In one exemplary embodiment, it is provided that the thickness of the side walls is different from the thickness of the bottom wall and/or different from the thickness of the rear wall and/or different from the thickness of the top wall. Such an exemplary embodiment of a muffle is particularly advantageous in order to have as little as possible deformation with a corresponding application of heat from an external heating element. In cooking appliances, particularly when a heating element is arranged outside the cooking chamber and thus in an intermediate space between the muffle and the housing, it can be required at least in some operating modes that the heating element is operated with a particularly high heat output. As a result, such a heating element, which is then in particular a resistance heating element, is particularly hot. Accordingly, temperatures of more than 700° C. occur here. These temperatures also act at least partially on the adjacent walls of the muffle. Thus it is provided when such a heating element is a top-heat and/or grill heating body, for example, that the adjacent top wall is then correspondingly also subjected to heat. Additionally or alternatively, this can also be the case for a bottom-heat heating body of the cooking appliance. As a result, a corresponding heat acts on a bottom wall of the muffle. The above-mentioned aspect of the invention is advantageous in order to maintain a high dimensional stability of the muffle in such specific configurations. In this context the walls are thus designed to be thicker or thinner as required in order to obtain, depending on the respective configurations, a particularly high level of inherent rigidity even with an application of very high heat from outside the muffle.

In one exemplary embodiment, the thickness of the side walls is smaller than the thickness of the bottom wall. Additionally or alternatively, the thickness of the side walls can be smaller than the thickness of the rear wall. In particular, in one exemplary embodiment, the thickness of the side walls can be smaller than the thickness of the top wall. Since according to the above-mentioned possible exemplary embodiment, heating elements are arranged adjacent to and above the top wall and/or adjacent to and below the bottom wall of the muffle, these walls of the muffle are particularly subjected to the application of heat. Thus in this context, it is particularly advantageous if these walls are thicker than the side walls which are arranged further away from the heating elements. Due to the container-like shape of a muffle and the aforementioned walls directly adjoining one another, mechanical stresses and tendencies to deformation occur or can be correspondingly transferred here. In order to have the corresponding deformation stability, it is particularly advantageous if the bottom wall and/or the top wall are thicker than the other walls of the muffle.

In one exemplary embodiment, the thickness of the side walls is smaller by a value of between 0.2 mm and 0.5 mm, in particular between 0.25 mm and 0.35 mm smaller than the thickness of the bottom wall and/or the thickness of the rear wall and/or the thickness of the top wall. Such a difference in values between the thinner walls and thicker walls permits the above-mentioned advantages to a particular degree. On the one hand, the thinner walls can be designed as required and do not have to be too thick. On the other hand, the thicker walls can be adapted in an improved manner to the potential application of higher heat. Moreover, particularly due to this difference, this avoids the occurrence of a significant weight asymmetry which might disadvantageously occur in the shape of the muffle. Thus this value difference in the thicknesses is particularly suitable for the aforementioned functionalities and advantages.

In one exemplary embodiment, the thickness of the side walls is between 0.4 mm and 0.8 mm, in particular between 0.4 mm and 0.6 mm.

In one exemplary embodiment, the thickness of the bottom wall is between 0.6 mm and 1.0 mm, in particular between 0.7 mm and 0.9 mm. In one exemplary embodiment, it can be provided that the thickness of the top wall is between 0.6 mm and 1.0 mm, in particular between 0.7 mm and 0.9 mm. These individual possible thickness values of the aforementioned walls permit a particularly high level of resistance to deformation of the muffle, in particular when a large amount of heat acts on these walls arranged adjacent to the heating element, due to the heating elements of the cooking appliance arranged outside the muffle.

In one exemplary embodiment, the muffle is configured from metal.

In one exemplary embodiment, it can be provided that the muffle is provided at least on the outer face at least in some regions with a material which has a heat resistance of up to 550° C., in particular of up to 530° C. in addition to a base material, such as for example steel. This enables a further protection of the walls of the muffle. The deformation stability is further increased thereby. In one exemplary embodiment, it is provided this applied material is a coating on the outer face of a base material of the wall of the muffle. In particular, this applied material is enamel with a heat resistance of up to 550° C., in particular up to 530° C.

A further independent aspect of the invention relates to a cooking appliance. The cooking appliance has a housing. The housing can be denoted as the outer housing. The cooking appliance also has a muffle. The muffle is a component which is separate from the housing. The muffle is arranged in the housing. The muffle defines a cooking chamber of the cooking appliance with walls. In particular, this muffle directly defines this cooking chamber with walls. Moreover, the cooking appliance has at least one, in particular strand-like or rod-like, first heating element, in particular extending two-dimensionally and repeatedly bent in a single main extension surface. The heating element is arranged outside the muffle in an intermediate space between the housing and the muffle. The first heating element is arranged as a top-heat and/or grill heating element in an upper intermediate space region of the intermediate space. This intermediate space region is formed between an upper wall of the muffle and a upper outer wall of the housing which is spaced apart therefrom and arranged at least substantially parallel thereto, when viewed in the height direction of the cooking appliance. Moreover, the cooking appliance also has at least one, in particular strand-like or rod-like, second heating element extending, in particular, in a single main extension plane and repeatedly bent. The second heating element is arranged outside the muffle in an intermediate space between the housing and the muffle. The second heating element is arranged as a bottom-heat and/or grill heating element in a lower intermediate space region of the intermediate space, when viewed in the height direction, wherein the intermediate space region is located between a bottom wall of the muffle and a lower outer wall of the housing which is spaced apart therefrom and arranged at least substantially parallel thereto.

In one exemplary embodiment, the first heating element, i.e. the top-heat and/or grill heating element, and the second heating element, i.e. the bottom-heat and/or grill heating element, are configured to be the same in terms of at least one electrical heating element parameter and/or in terms of at least one geometric heating element parameter. This provides a cooking appliance which is adapted relative to a bottom-heat and/or grill heating element and a top-heat and/or grill heating element, or these locally and functionally specific heating elements are adapted to one another. Thus the heating functions can be improved. In particular, the heating elements can also be operated as required. Not least, the bottom-heat and/or grill heating body or the bottom-heat and/or grill heating element can also be used for functions for which it is not suitable in conventional appliances. This is the case, in particular, when modes of operation, in particular with specific heat outputs, are made possible with the bottom-heat and/or grill heating element which were previously not possible.

Thus it is also possible, for example, that a bottom-heat heating element can be operated such that in the cooking chamber it is also possible, for example, to prepare a pizza on the bottom wall of the muffle. Thus it is also possible to provide a bottom-heat heating element which is practically a pizza preparation heating element. A grill function can also be provided by the bottom-heat heating body. Thus grilling from below is also possible.

In one exemplary embodiment, an electrical heating element parameter is a maximum heat output of the entire heating element and/or a maximum heat output of at least one heating sub-element of a plurality of heating sub-elements of the heating element, when a heating element has a plurality of separate heating sub-elements. In particular, in such an exemplary embodiment this plurality of, in particular at least two separate, heating sub-elements are arranged in a common main extension surface, or extend in this main extension surface two-dimensionally with their main extension dimensions. These heating sub-elements can be arranged so as to be guided within one another in this main extension surface or one heating sub-element can surround the other heating sub-element at least in some regions, when viewed in this main extension surface. The outer heating sub-element surrounds the other inner heating sub-element with its windings in a spaced-apart manner.

In one exemplary embodiment, a geometric heating element parameter, for example, is a strand length of a heating element and/or a strand length of at least one heating sub-element of the plurality of heating sub-elements of the heating element. In a further exemplary embodiment, a geometric heating element parameter can also be a path of a strand shape of the heating element and/or the size of the heating element in one plane.

In one exemplary embodiment, the maximum heat outputs of the first heating element and the second heating element can be identical.

In principle, in one exemplary embodiment, it is also possible that all electrical heating element parameters and/or all geometric heating element parameters of these two heating elements are identical. In the exemplary embodiment, they can also be completely identical heating elements.

In one exemplary embodiment, the maximum heat output of the first heating element is between 3.0 kW and 4.0 KW, in particular between 3.2 kW and 3.6 kW. Additionally or alternatively, in one exemplary embodiment the maximum heat output of the second heating element can be between 3.0 kW and 4.0 kW, in particular between 3.2 kW and 3.6 kW.

The cooking appliance can also be configured with a pizza preparation operating mode specifically when the bottom-heat heating body is similar to or the same as the top-heat heating body and, in particular, a corresponding maximum heat output is possible. Additionally or alternatively it is also possible that, due to this increased heat output of the bottom-heat heating body, grilling is possible in the cooking chamber in which the grill heating body is arranged below the bottom wall of the muffle, namely is formed by the bottom-heat heating body. This enables a grilling function with a heating body which delivers the heat output from below for grilling. Moreover, this also achieves a pyrolysis mode which delivers a corresponding heat output from below, from the bottom-heat heating body. High-performance cooking with a corresponding heat output from below is also possible. For example, this can be advantageous for preparing fruit. In particular, the drying of such fruit, such as for example plums or the like, can be carried out in the cooking chamber.

It is also generally advantageous to position the heating elements outside the cooking chamber since these heating elements are then not subjected to the steam and moisture as can occur in the cooking chamber. This avoids damage to the heating elements due to corrosion. As a result, a material which does not necessarily have to be corrosion-resistant can be used for the heating elements.

A further independent aspect of the invention relates to a cooking appliance. The cooking appliance has a housing. This housing can also be denoted as the outer housing. The cooking appliance also has a muffle. The muffle is a component which is separate from the housing. The muffle is arranged in the housing. The muffle defines a cooking chamber of the cooking appliance with walls. The muffle directly defines this cooking chamber with walls. The muffle has a top wall, a bottom wall, a rear wall and side walls, as walls. The top wall and the side walls are provided as separate components which are connected by an unreleasable connection. Additionally or alternatively, it can be provided that the component which is provided, for example, separately from the side walls is connected by an unreleasable connection to the side walls. The top wall and/or the bottom wall have a trough shape. This muffle can be designed to be more rigid per se, by means of such a modular construction of the muffle. The module parts which are initially produced separately and provided, in particular, in their final form, considered per se, namely the top wall and/or the bottom wall and the separate side walls, make it possible to design these individual components separately. As a result, these individual components, considered per se, can be adapted more individually to the requirements of a high level of rigidity of the entire muffle.

Particularly if this rigidity and deformation stability are required during the operation of at least one heating element of the cooking appliance, the requirements can be better met by this construction of the muffle. The trough shape of two very exposed module components of this muffle, namely the top wall and the bottom wall, also particularly permits in this context a higher level of rigidity of these components, considered per se. Thus in this context a top and a bottom termination of this muffle can be constructed in a more stable manner, when considered per se. In this context, a trough shape in particular permits a higher torsional rigidity. This also enables the mechanical coupling, in particular due to the unreleasable connections to the side walls thus generated, to lead to an improvement in the overall rigidity of the muffle. The unreleasable connections in this context represent interfaces between the individual components of the muffle, which is of modular construction, when they are connected together. Unreleasable connections are those which are not reversibly formed and cannot be released again without damaging or destroying at least one of the components. An unreleasable connection, for example, is a welded connection. This is also able to be recognized as such and identified as such on the finished muffle, so that in this context it is also identified that the individual components of the muffle were previously produced in this form, considered per se, and thus already before the unreleasable connection, and then subsequently joined together.

In one exemplary embodiment, both the top wall and the bottom wall have a trough shape. The above-mentioned advantages are improved further thereby. This achieves a particularly high level of rigidity and high deformational stability, in particular with a corresponding application of heat from a resistance heating element of the cooking appliance. When a heating element is arranged as a top-heat heating element directly adjacent to the top wall, a deformation of this top wall is significantly reduced compared to conventional muffles. Additionally or alternatively, the same applies to a bottom wall when, for example, a bottom-heat heating element of the cooking appliance is arranged immediately adjacent to this bottom wall, in particular when it is configured as a resistance heating element. This is because particularly in resistance heating elements high heat is also correspondingly directly discharged to these adjacent walls, so that these walls heat up to a significant degree.

In one exemplary embodiment, the top wall has a trough ceiling and a trough collar. The trough collar is arranged at least in some regions on the edge of the trough ceiling peripherally around this trough ceiling. In one exemplary embodiment, the trough ceiling is, in particular, bulged in the manner of a dome at least in some regions. This bulging of a specific sub-element of the top wall contributes to improved rigidity and to greater deformation stability.

In one exemplary embodiment, the bottom wall has a trough floor and a trough collar which is arranged peripherally on the edge of the trough floor at least in some regions, wherein the trough floor is bulged, in particular in the manner of a dome, at least in some regions. In this regard, the corresponding advantages apply to the bottom wall as have been mentioned in the aforementioned exemplary embodiment relating to the top wall.

In one exemplary embodiment, the trough ceiling has a bulging so that a spacing between a highest point of the bulging and a lowest point of the trough ceiling is between 10 mm and 15 mm, in particular between 11 mm and 13 mm, when measured in the height direction. This achieves a bulging which is relatively flat, on the one hand, so that an installation space in the height direction is not undesirably increased. On the other hand, a corresponding reinforcement is achieved by this bulging, in comparison with a completely planar trough ceiling.

In one exemplary embodiment, the trough floor of the bottom wall can be correspondingly bulged. The corresponding advantages are also achieved here.

In one exemplary embodiment, the top wall has a trough ceiling and a trough collar. The trough collar is arranged at least in some regions peripherally on an edge of the trough ceiling. The trough collar forms the side wall of the trough shape. A flange is arranged on the trough collar, in particular protruding laterally therefrom. The flange is configured, in particular, in one piece with the trough collar. In particular, the entire top wall is configured in one piece with the trough ceiling and the trough collar, in particular also with the optionally present additional flange. For example, such a shape of the top wall can be produced by a corresponding forming process from a blank which is already provided, in particular a metal plate. In one exemplary embodiment, the same can be carried out with the bottom wall.

A further reinforcement of the top wall, in particular also the trough collar, is achieved by this protruding flange.

In one exemplary embodiment, such a laterally protruding flange can also be integrally formed on a trough collar of the bottom wall. The corresponding advantages also apply here as have been mentioned relative to the top wall.

In one exemplary embodiment, such a flange is a counter-coupling element which is provided for coupling to a distancing unit of the cooking appliance. In particular, such a distancing unit can be mechanically coupled directly to this counter-coupling element. The distancing unit is provided, in particular, to position the heating element spaced apart from the adjacent top wall or the heating element adjacent to the bottom wall, as intended. Thus this flange is designed to be multifunctional. This is, on the one hand, for reinforcing the top wall or the bottom wall and, on the other hand, for direct mechanical coupling to such a separate distancing unit.

In one exemplary embodiment, the flange is integrally formed on a free edge of the trough collar remote from the trough ceiling. In particular, this flange is arranged protruding laterally from the trough collar and protruding outwardly. This flange is thus a flat projection or a strip-shaped projection.

The flange can be configured at least 50%, in particular at least 60%, in particular at least 70%, in particular at least 80%, in particular at least 90%, over the entire length of a side wall of the trough collar. Additionally or alternatively, such a flange can also be at least 50%, in particular at least 60%, in particular at least 70% over the length of a rear partial section of the trough collar.

In one exemplary embodiment, the side walls of the muffle are unreleasably connected directly to the trough collar. The unreleasable connection, for example a welded connection, is thus directly connected between an edge of the side wall and the trough collar, for example the top wall and/or the trough collar of the bottom wall. It can also be provided that a side wall, when viewed in the height direction, is arranged overlapping with the top wall, in particular the trough collar of the top wall. In a further exemplary embodiment, additionally or alternatively the same can be provided with the bottom wall. This is because a further improvement in the stability can be achieved by such a partial immersion of the side walls in the trough shape of the top wall and/or in the trough shape of the bottom wall, when viewed in the height direction. In particular, in this context the releasable connection can be generated more comprehensively and/or more extensively. As a result, the corresponding interfaces between the individual module parts of the muffle can also be designed to be more stable and more resilient.

In one exemplary embodiment, the thickness of the side walls is different from the thickness of the bottom wall. Additionally or alternatively, it can be provided that the thickness of the side walls is different from the thickness of the rear wall and/or different from the thickness of the top wall. In particular, the thickness of the side walls is smaller than the thickness of the top wall and/or smaller than the thickness of the bottom wall.

In one exemplary embodiment, the muffle has a front flange as a further separate module component. This flange is formed as a preferably continuous frame which bears on the front face against the top wall and/or the bottom wall and/or the side walls in the assembled state of the muffle. This initially prefabricated front flange can also be provided here, and then subsequently connected to further walls of the muffle by a mechanical connection, in particular an unreleasable connection, such as a welded connection. Preferably, this front flange has a thickness of between 1.1 mm and 1.4 mm, in particular between 1.2 mm and 1.3 mm. In one exemplary embodiment, the front flange is configured with a greater thickness than the thickness of the top wall and/or the thickness of the bottom wall.

Sa qw23

In one exemplary embodiment, the bottom wall is configured to be the same shape and/or size and/or of the same material as the top wall. In one exemplary embodiment, these side walls can be formed with the rear wall as an integrally produced U-shaped module, wherein this U-shaped module is connected in each case directly to the separate top wall and the separate bottom wall by unreleasable connections.

In one exemplary embodiment, it can be provided that the side walls have additional embossed portions. This increases the inherent rigidity of these side walls. Additionally or alternatively, the same can also be provided in the rear wall.

Preferably, the unreleasable connections are formed as welded connections, in particular pinch-seam welded connections. These are particularly stable and resistant, even in the case of the application of high heat and high mechanical stresses.

A further independent aspect of the invention relates to a cooking appliance. The cooking appliance has a housing. The housing can be denoted as the outer housing. The cooking appliance also has a muffle. The muffle is a component which is separate from the housing. The muffle is arranged in the housing. The muffle defines a cooking chamber of the cooking appliance with walls. In particular, the muffle directly defines this cooking chamber with walls. The cooking appliance also has at least one first, in particular strand-like or rod-like, heating element which extends two-dimensionally, in particular, in a single main extension surface and is repeatedly bent. The heating element is arranged outside the muffle in an intermediate space between the housing and the muffle. The first heating element is arranged as a top-heat heating element, in particular a top-heat and/or grill heating element in an upper intermediate space region of the intermediate space. This intermediate space region is formed between an upper wall of the muffle, when viewed in the height direction of the cooking appliance, and an upper outer wall of the housing which is spaced apart therefrom and arranged at least substantially parallel thereto. Moreover, the cooking appliance has at least one, in particular strand-like or rod-like, second heating element which extends, in particular, in a single main extension plane and is repeatedly bent. The second heating element is arranged outside the muffle in an intermediate space between the housing and the muffle. The second heating element is arranged as a bottom-heat heating element, in particular as a bottom-heat and/or grill heating element, in a lower intermediate space region of the intermediate space, when viewed in the height direction, wherein the intermediate space region is located between a bottom wall of the muffle and a lower outer wall of the housing which is spaced apart therefrom and arranged at least substantially parallel thereto.

In one exemplary embodiment, the first heating element, i.e. the top-heat and/or grill heating element, and the second heating element, i.e. the bottom-heat and/or grill heating element, are configured the same in terms of at least one electrical heating element parameter and/or in terms of at least one geometric heating element parameter. This provides a cooking appliance which is adapted to a bottom-heat and/or grill heating element and a top-heat and/or grill heating element, or these locally and functionally specific heating elements are adapted to one another. Thus heating functions can be improved. In particular, the heating elements can also be operated as required. Not least, the bottom-heat and/or grill heating body or the bottom-heat and/or grill heating element can also be used for functions for which it is not suitable in conventional appliances. This is the case, in particular, when modes of operation, in particular with specific heat outputs, are made possible with the bottom-heat and/or grill heating element which were previously not possible.

In one exemplary embodiment, the cooking appliance has a control apparatus. This control apparatus is designed such that in at least one operating mode of the cooking appliance, in which the top-heat heating element, preferably the top-heat and/or grill heating element, the bottom-heat heating element, preferably the bottom-heat and/or grill heating element, are activated at the same time, the actual heat output of one of the two heating elements is set differently from the actual heat output of the other heating element. Thus in the cooking appliance it is also possible via the control apparatus to set different heat outputs of the individual activated heating elements. This enables more individual preparation processes to be achieved. If, for example, less actual heat output is required from the bottom heat-heating element than from the top-heat heating element, this can be set by the control apparatus. The same can also be the case in reverse, for example, when a larger actual heat output of the bottom-heat heating element in comparison with the top-heat heating element is required for the preparation process.

Generally it is possible to set an actual heat output differently from a maximum heat output of one of the heating elements. Thus a very individual and varied configuration of the overall heat output of the two heating elements can be set when they are both activated.

It is generally possible, and also in this context, that the actual heat output selected or set via the control apparatus are evaluated by a control unit of the cooking appliance and the heating elements are correspondingly activated by means of this control unit. It is also possible in this context to monitor the activated heating elements via a control algorithm and correspondingly to regulate the desired actual heat outputs.

It can be provided that the two heating elements have the same maximum heat output. Rather than simply setting the maximum heat output, however, this aspect of the invention also makes it possible to set an actual heat output which is different from the maximum heat output in at least one heating element.

In one exemplary embodiment, at least one of the actual heat outputs of these aforementioned at least two heating elements of the cooking appliance can be set as a percentage of the maximum heat output of this heating element. In one exemplary embodiment this can also be carried out via the control apparatus. It is also possible in this context that the actual heat outputs of these at least two heating elements can be set at a percentage ratio to one another by the control apparatus. Both a continuous setting and a setting in discrete steps can take place here. It is also possible in this context to predetermine discrete steps which can then be selected. These specific steps can be in each case percentages of a maximum heat output. In a further exemplary embodiment, it can also be provided that at least one of the two heating elements has two separate heating sub-elements. These can be operated independently of one another. In one exemplary embodiment, an individual actual heat output of the respective heating element can also be selected and set by selecting one of these heating sub-elements. Thus in one exemplary embodiment, at least three different actual heat outputs of the heating element can be set. This can be implemented, on the one hand, by the heat output of a first heating sub-element and, on the other hand, by the heat output of the at least second further heating sub-element of this heating element, if respectively only one of the two heating elements is activated. In a further selection process, however, it is possible to operate jointly both heating sub-elements of this heating element which has at least these two heating sub-elements. Then a third heat output of the heating element is provided. This is therefore, in particular, the maximum heat output of the heating element.

Aspects of the invention and/or advantageous exemplary embodiments thereof are advantageous exemplary embodiments of a further independent aspect of the invention, as has been mentioned above. Thus all of the disclosed exemplary embodiments in each aforementioned independent aspect of the invention are possible exemplary embodiments.

Positions and orientations provided when the appliance is used as intended and arranged as intended, are specified by the terms “top”, “bottom”, “front”, “rear”, “horizontal”, “vertical” “depth direction”, “width direction”, “height direction”, etc.

Further features of the invention are found in the claims, the figures and the description of the figures. The features and combinations of features mentioned above in the description, and the features and combinations of features mentioned below in the description of the figures and/or shown individually in the figures, are not only able to be used in the respectively specified combination but also in other combinations or individually without departing from the scope of the invention. Thus embodiments which are not explicitly shown and described in the figures but which emerge from and which can be generated by separate combinations of features from the described embodiments are thus to be regarded as encompassed and disclosed. Embodiments and combinations of features which thus do not have all of the features of an originally formulated independent claim, are also to be regarded as disclosed.

Exemplary embodiments of the invention are described in more detail hereinafter with reference to schematic drawings, in which:

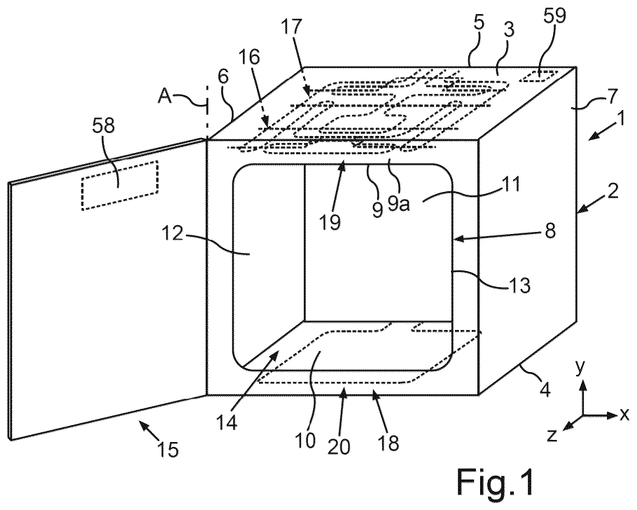

FIG. 1 shows a perspective view of an exemplary embodiment of a cooking appliance according to the invention;

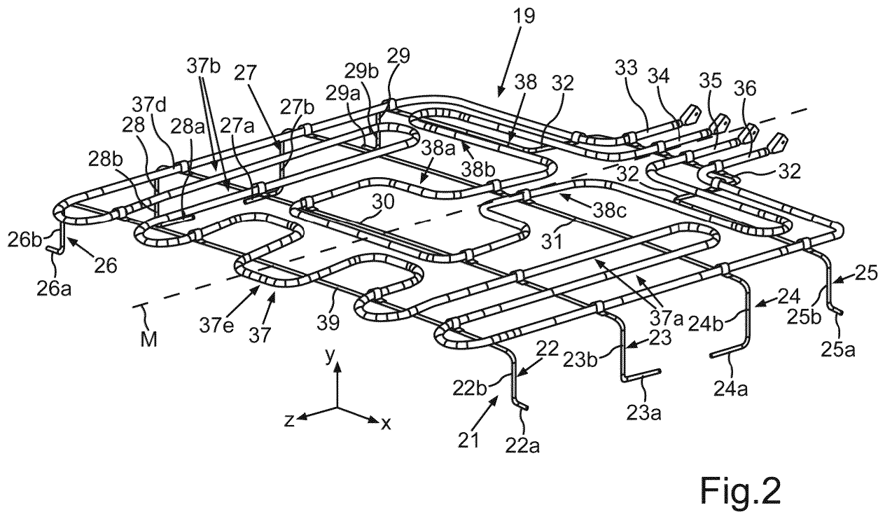

FIG. 2 shows a perspective view of an exemplary embodiment of a heating element according to the invention with an exemplary embodiment of a distancing unit according to the invention;

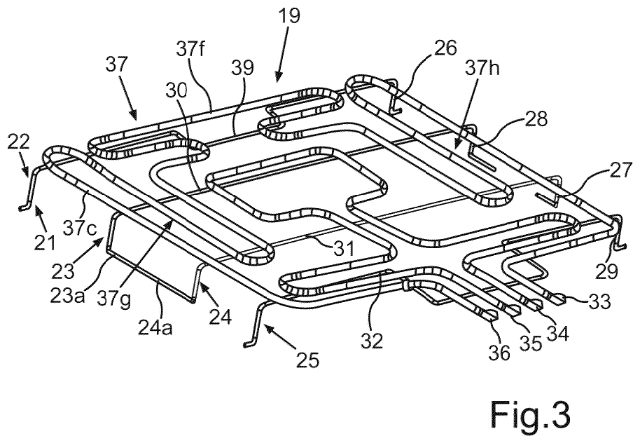

FIG. 3 shows a perspective view of a further exemplary embodiment of a heating element according to the invention with an exemplary embodiment of a distancing unit according to the invention;

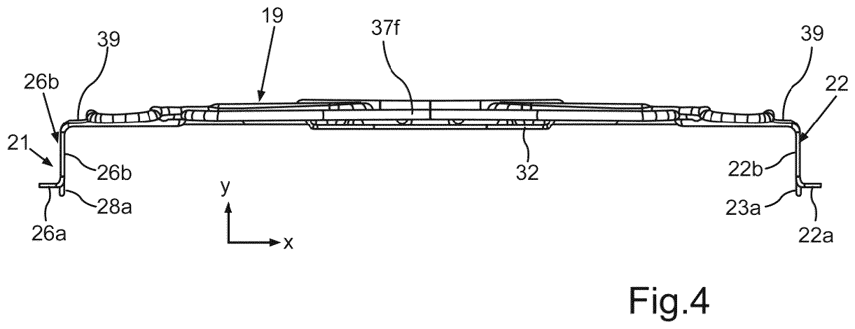

FIG. 4 shows a side view of the arrangement according to FIG. 3;

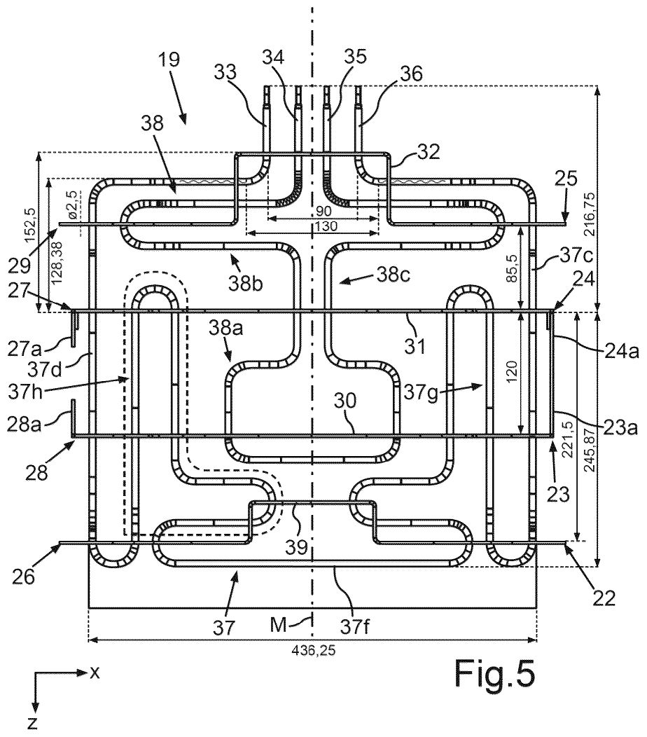

FIG. 5 shows a plan view of the arrangement according to FIG. 3;

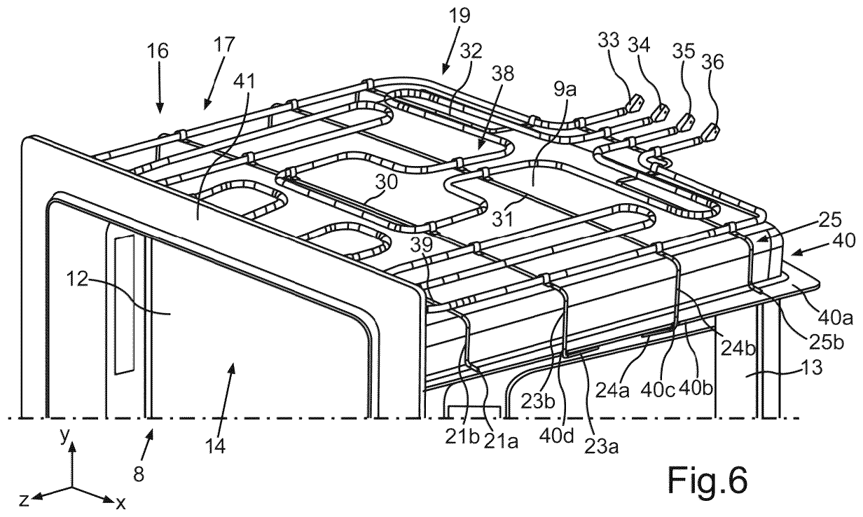

FIG. 6 shows a perspective view of a partial region of an exemplary embodiment of a cooking appliance with specific components;

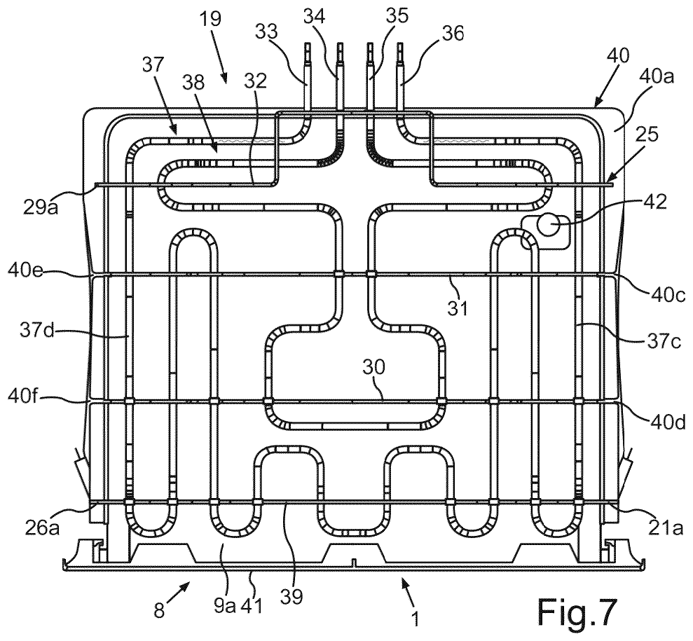

FIG. 7 shows a plan view of the arrangement according to FIG. 6;

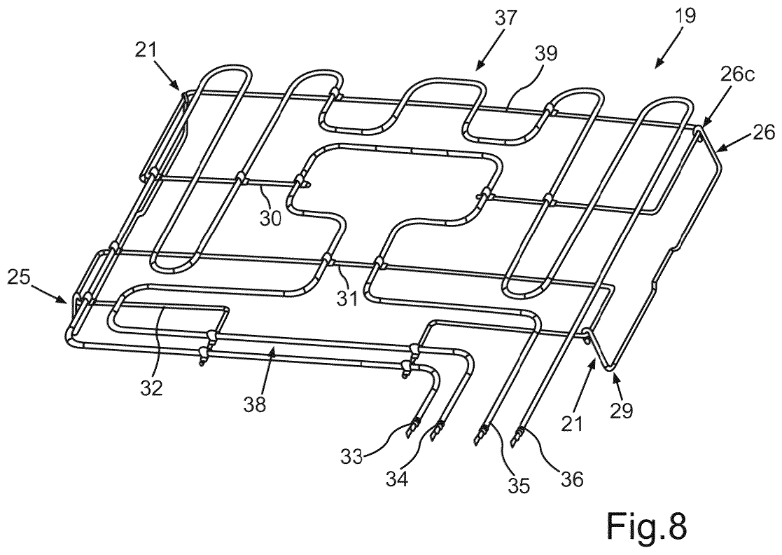

FIG. 8 shows a perspective view of a further exemplary embodiment of a heating element according to the invention with an exemplary embodiment of a distancing unit according to the invention;

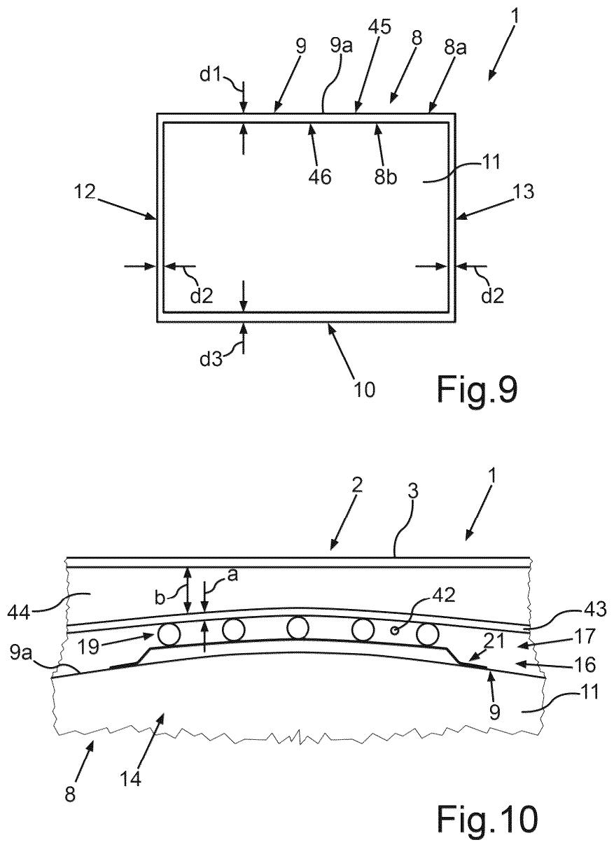

FIG. 9 shows a schematic view of an exemplary embodiment of a muffle of a cooking appliance according to the invention;

FIG. 10 shows a schematic sectional view of sub-components of an exemplary embodiment of a cooking appliance according to the invention;

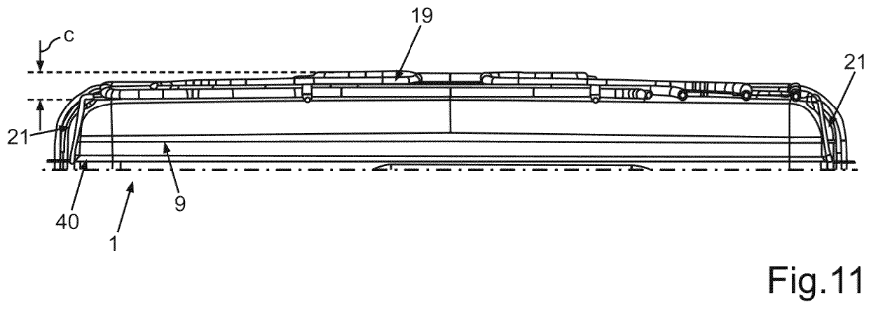

FIG. 11 shows a side view of a partial region of an exemplary embodiment of a cooking appliance according to the invention;

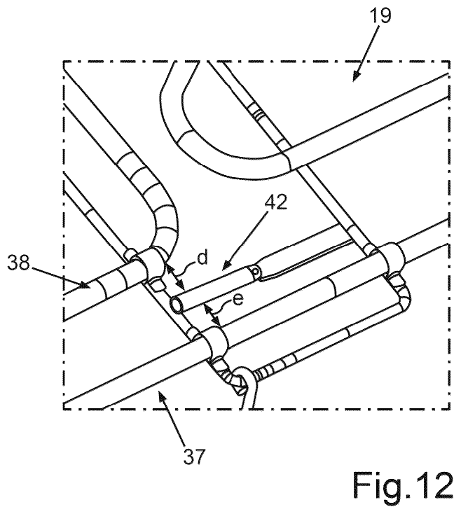

FIG. 12 shows a partial view of heating sub-elements of a heating element with a temperature sensor of an exemplary embodiment of a cooking appliance according to the invention;

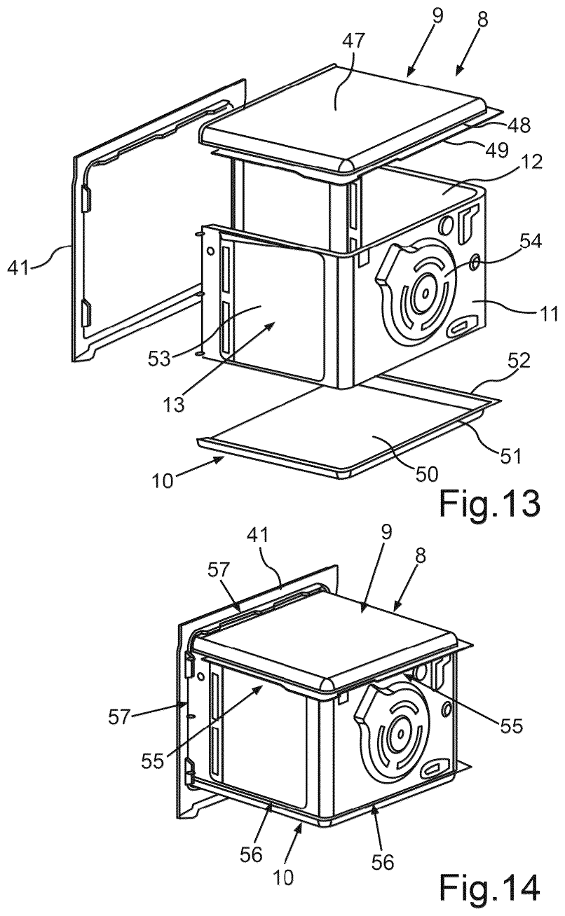

FIG. 13 shows an exploded view of an exemplary embodiment of a muffle according to the invention of an exemplary embodiment of a cooking appliance according to the invention; and

FIG. 14 shows the muffle according to FIG. 13 in the assembled state.

Elements which are the same or functionally the same are provided with the same reference characters in the figures.

In FIG. 1 an exemplary embodiment of a cooking appliance 1 is shown in a perspective view. The cooking appliance 1 can be an oven. The cooking appliance 1 can be a microwave cooking appliance or a steam cooking appliance. It is also possible that the cooking appliance is an oven with a microwave function and/or a steam cooking function.

The cooking appliance 1 has a first housing 2. This housing can also be denoted as the outer housing. The housing 2 has a top wall 3, a bottom wall 4, a rear wall 5 and side walls 6 and 7. The cooking appliance 1 also has a muffle 8. The muffle 8 is a component of the cooking appliance 1 which is separate from the housing 2. The muffle 8 is received in the housing 2. The muffle 8 is configured from metal. It can be made of steel. The muffle 8 has a top wall 9, a bottom wall 10, a rear wall 11 and opposing side walls 12 and 13. A cooking chamber 14 of the cooking appliance 1 is defined by the muffle 8. In particular, the cooking chamber 14 is directly defined at least in some regions by walls of the muffle 8. Moreover the cooking appliance 1 has a door 15. This door is movably arranged on the housing 2 and/or the muffle 8. The door can be pivoted here about a vertical axis A. The door 15 is arranged for closing the cooking chamber 14 on the front side.

An intermediate space 16 is formed between the muffle 8 and the housing 2. The intermediate space 16 has an upper intermediate space region 17 in the height direction (y-direction) of the cooking appliance 1. Moreover, when viewed in this height direction, the intermediate space 16 has a lower intermediate space region 18. The upper intermediate space region 17 extends in the height direction between the top wall 9 of the muffle 8 and the top wall 3 of the housing 2. The lower intermediate space region 18 extends between the bottom wall 10 of the muffle 8 and the bottom wall 4 of the housing 2. In one exemplary embodiment, the cooking appliance 1 has a heating element 19. In the exemplary embodiment shown, the heating element 19 is arranged outside the cooking chamber 14. Here the heating element is arranged in the intermediate space 16, in particular the upper intermediate space region 17. The heating element 19 is a resistance heating element. As indicated in FIG. 1, the heating element is formed in a strand-like or rod-shaped manner. This strand or this rod is configured to be repeatedly bent or repeatedly wound. The heating element 19 is a top-heat heating element or a grill heating element. In particular, it is a top-heat and/or grill heating element. In one exemplary embodiment, the cooking appliance 1 has a further heating element 20. This heating element 20 is arranged outside the cooking chamber 14. In particular, this heating element is arranged in the intermediate space, preferably in the lower intermediate space region 18. This heating element 20, in particular, is a bottom-heat heating element. The heating element can also be a bottom-heat and/or grill heating element of the cooking appliance 1.

In one exemplary embodiment, the heating element 19 is arranged spaced apart from the top wall 9 in the intermediate space region 17. In particular, the heating element is also arranged spaced apart from the top wall 3 of the housing 2. The heating element 19 is formed with its main extension in a main extension surface. This is spanned, in particular, by the width direction (x-direction) and the depth direction (z-direction) of the cooking appliance 1. The main extension surface can be planar or curved. The strand shape having the curved shape of the heating element 19 is thus placed practically in this horizontal main extension surface. In one exemplary embodiment, the heating element 19 is arranged by a distancing unit 21 (as shown in FIG. 2) of the cooking appliance 1 in a spaced apart manner from the wall 9, in particular an outer face 9a of the wall 9 remote from the cooking chamber 14. In one exemplary embodiment, this distancing unit 21 has a plurality of distancing rods 22, 23, 24, 25, 26, 27, 28 and 29. The number and arrangement of these distancing rods 22 to 29 is merely to be understood as by way of example. These distancing rods 22 to 29 are oriented at least in some portions so as to protrude from the main extension surface which is spanned by the main dimensions of the heating element 19, considered in terms of size.

In the exemplary embodiment shown, therefore, these distancing rods 22 to 29 protrude downwardly from this main extension surface in which the main extension or the main dimension of the heating element 19 is formed.

The heating element 19 is arranged with this distancing unit 21 positioned from above on the muffle 8. This means that this distancing unit 21 is positioned directly on the muffle 8. In one exemplary embodiment, therefore, the distancing rods 22 to 29 can be positioned directly on the muffle 8 with their cross-sectional surfaces.

In a further exemplary embodiment, as shown in FIG. 2, at least one distancing rod has a bent-back portion at one end which is remote from the heating element 19. Thus it is provided in the distancing rod 22 that it has a bent-back portion 22a on the end side. This bent-back portion adjoins the side remote from the heating element 19 or the remote end of a further rod part 22b. This bent-back portion 22a in the distancing rod 22 is a positioning coupling part by which the distancing unit 21, in particular, is directly positioned on a side, which faces the heating element 19, of a counter-coupling element of the cooking appliance 1 for the distance-setting coupling. As can be identified in one exemplary embodiment, this bent-back portion 22a is arranged at an angle of 85° and 95°, in particular 90°, relative to the further rod part 22b directly adjoining thereto. In the exemplary embodiment, at least one further distancing rod is correspondingly formed on this side of the distancing unit 21, here the distancing rod 25 with a bent-back portion 25a and a rod part 25b as the distancing rod 22. In one exemplary embodiment, the same is also provided in the distancing rod 26 which also has a bent-back portion 26a and a rod part 26b. Accordingly, in one exemplary embodiment the distancing rod 29 has a bent-back portion 29a and a rod part 29b adjoining thereto. As can be identified here, the bent-back portions 22a, 25a, 26a, and 29a extend in the horizontal direction, in particular with their longitudinal axes in the width direction. In one exemplary embodiment, they are arranged substantially on the four corner regions of the heating element 19.

Moreover, in one exemplary embodiment, differently formed distancing rods are provided. Thus, for example, the distancing rod 23 also has a bent-back portion 23a on the end side. This adjoins the side remote from the heating element 19 or the remote end of a further rod part 23b of the distancing rod 23. As can be identified here, this bent-back portion 23a with its longitudinal axis extends in the depth direction (z-direction). Moreover, it is provided that, when viewed in the height direction (y-direction), the bent-back portion 23a is located further down and thus further removed from the heating element 19 than the bent-back portion 22a of the distancing rod 22. In one exemplary embodiment, this height offset of the bent-back portion 23a is also formed in comparison with the bent-back portions 25a, 26a and 29a. In one exemplary embodiment, the distancing rod 24 is configured according to the distancing rod 23. A bent-back portion 24a and a rod part 24b are also provided here. In a further exemplary embodiment, this is also provided in the distancing rod 28. In one exemplary embodiment, this distancing rod is also formed with a bent-back portion 28a and a rod part 28b adjoining thereto. In a further exemplary embodiment, the same is formed by the bent-back portion 27a and the rod part 27b of the distancing rod 27. In particular, the bent-back portions 23a, 24a, 27a and 28a are arranged at the same or substantially the same vertical position. As can also be identified, these bent-back portions 23a and 24a extend with their longitudinal axes, when viewed in the depth direction. In particular, these bent-back portions face one another. In one exemplary embodiment, this also applies to the bent-back portions 27a and 28a. In a further exemplary embodiment, it is also possible that the bent-back portions 23a and 24a and/or the bent-back portions 27a and 28a are directly connected together. As a result, in practice a continuous rod consisting of bent-back portions is formed, when viewed in the depth direction.

In one exemplary embodiment, a rear-engaging coupling part is respectively formed by these bent-back portions 23a, 24a, 27a, and 28a with which the distancing unit 21 bears, in particular directly engaging behind, on a side of a counter-coupling element of the cooking appliance 1, remote from the heating element 19, for the distance-setting coupling.

In one exemplary embodiment, the cooking appliance 1 has position securing elements. These position securing elements are formed here by position securing rods 30, 31, 32 and 39. The number is to be understood here merely by way of example. In one exemplary embodiment, such a position securing rod 39, which is in particular linear, is arranged directly on a lower face of the heating element 19. In particular, a fixed connection is configured here between a position securing rod 30 to 32, 39 and the heating element 19. A preferably unreleasable connection can be provided here. For example, a welded connection can be implemented. As can be identified here, a position securing rod 30, 31 and 39 extends over the entire width of a heating element 19. In the exemplary embodiment, the further position securing element or the further position securing rod 32 is not configured over the entire width but extends on opposing sides of a central axis M with in each case corresponding position securing rod portions. In one exemplary embodiment, however, this position securing rod 32 can also be a single continuous rod as shown in FIG. 2. Relative thereto this position securing rod 32 is not configured to be completely linear but angled. As a result, a positional securing of electrical, in particular rod-shaped, connecting pieces 33, 34, 35 and 36 is achieved. A partial piece of the position securing rod 32 is arranged directly on the lower face of these connecting pieces 33 to 36.

In one exemplary embodiment, a distancing rod is arranged in each case on at least one position securing rod 39, in particular at opposing ends. In particular, the distancing rods are configured in one piece with a position securing rod. Thus it is provided, for example, that the distancing rods 22 and 26 are integrally formed directly on opposing ends of the position securing rod 39. This results in a U-shaped carrier and/or positioning rod.

In one exemplary embodiment, this can also be provided in the further position securing rods 30, 31 and 32 which are preferably present. The distancing rods 23, 24, 25, 27, 28 and 29 which are arranged angled back relative to the position securing rods 30 to 32 are also integrally formed in each case at opposing ends on the end side. This results in the formation of a rod frame on which the heating element 19 is positioned.

In a preferred exemplary embodiment, the heating element 19 has at least two heating sub-elements 37 and 38. The two heating sub-elements 27 and 38 are separate and independent of one another. Thus the first strand-like or rod-shaped heating sub-element 37 which is repeatedly bent has two electrical connecting pieces 33 and 36. The second heating sub-element 38, which is also configured in a strand-like or rod-shaped manner and repeatedly bent, has separate electrical connecting pieces 34 and 35. As can be identified in the exemplary embodiment of FIG. 2, both heating sub-elements 37 and 38 extend with their bent shape in a main extension surface. This can be a horizontal surface. In one exemplary embodiment, they both extend in the same main extension surface which is spanned by the width direction and the depth direction of the cooking appliance 1. As can also be identified in a projection view of this main extension surface, the one heating sub-element is surrounded by the other heating sub-element. Here it is provided that, when viewed in this projection plane, the first heating sub-element 37 surrounds the second heating sub-element 38 over the periphery. The windings of the one heating sub-element 37 encompass the windings of the other heating sub-element 38 in a spaced-apart manner. The second heating sub-element 38 is surrounded by the first heating sub-element in the manner of a frame in this main extension surface.

In one exemplary embodiment, when viewed in this projection plane, the second heating sub-element 38 has an asymmetrical H-shape. Thus a smaller H-shaped limb 38a, a larger H-shaped limb 38b and a connecting limb 38c are formed by the strand portions of the entire strand shape of this second heating sub-element 38. In this context, the first H-shaped limb 38a is shorter but wider than the other H-shaped limb 38b.

As can also be identified, the first heating sub-element 37 has U-shaped strand portions 37a and 37b. In this regard, they are arranged relative to one another symmetrically to the central axis M. Viewed in the depth direction, these U-shaped strand portions 37a and 37a are arranged, in particular, overlapping with the short H-shaped limb 38a and the connecting limb 38c. An overlapping arrangement with the longer H-shaped limb 38b in this depth direction is, in particular, not provided here. However, in this context, in particular, an overlapping arrangement between this H-shaped limb 38b and these U-shaped strand portions 37a and 37b is formed in the width direction or x-direction. In the width direction these U-shaped strand portions 37a and 37b do not overlap, in particular, with the shorter H-shaped limb 38a and the connecting limb 38c. When viewed in the width direction, these U-shaped strand portions 37a and 37b, in particular, are the components or strand portions of the first heating sub-element 37 which are located closest to the shorter H-shaped limb 38a and the connecting limb 38c.

As can be identified in FIG. 2, in a further exemplary embodiment it is provided that, when viewed in the width direction (x-direction), further strand portions 37a and 37b which run in particular parallel thereto, outwardly adjoin these U-shaped strand portions 37c and 37d. As a result, in one exemplary embodiment, a double U-shape of these strand portions 37a and 37b is formed in each case. For example, in one exemplary embodiment, a repeatedly bent connecting structure 37e of the first heating sub-element can be configured on the sides of these U-shaped strand portions 37a and 37b which face one another. As shown in FIG. 2, this can in turn be a repeated U-shape oriented in the depth direction, in particular having at least two, preferably three, directly adjoining U-shaped strand regions. In particular, this can be five U-shaped regions oriented alternately to one another, as is implemented in FIG. 2.

In a further exemplary embodiment of the heating element 19 as is shown in FIG. 3 in a perspective view, the first heating sub-element 37 can be formed differently from FIG. 2 in the connecting region of the U-shaped strand portions 37a and 37b which face one another. As can be identified in FIG. 3, a linear strand 37f of the first heating sub-element 37 is formed on the front face and defines the strand shape. This transitions into curved U-shaped regions.

As a result, instead of the U-shaped strand portions 37a and 37b, the U-shape thereof being open on the side remote from the electrical connecting pieces 33 to 36, an L-shape of the strand portions is produced in each case. Here an L-shaped strand portion 37g and 37h is formed in each case. In each case, a virtually hollow L-shape is formed in this regard. In one exemplary embodiment, it can also be identified in FIG. 3 that here the bent-back portions 23a and 24a are directly connected together and thus a one-piece rod is implemented as a bent-back portion.

In FIG. 4 a side view can be identified of the arrangement according to FIG. 3.

As can also be identified here, it is possible to see in the height direction (y-direction) the above-described height offset between the bent-back portions 26a and 23a and the bent-back portions 22a and 23a which can be identified in FIG. 4. In particular, this height offset is such that a lower edge of the higher bent-back portions 26a is higher, in particular with a spacing, than an upper edge of the bent-back portion 28a. The same applies to the bent-back portions 22a and 23a and to the further bent-back portions, shown by way of example in FIG. 2 and FIG. 3. As a result, a gap is formed between a lower face of the higher bent-back portion 26a and an upper face of the lower bent-back portion 28a. This is dimensioned, in particular, such that a counter-coupling element of the cooking appliance 1 can be arranged therebetween. A corresponding height offset is also formed, in particular, in the other pairs of bent-back portions which are present here, as can be identified in FIG. 4 and in particular in FIG. 2.

As can also be identified in FIG. 4, in one exemplary embodiment, a distancing rod 22 to 29 extends in the height direction over a height which is greater by a multiple than a diameter of a rod of the heating element 19. Preferably, a height of the distancing rods 21 to 29 is such that in the mounted state of this arrangement according to FIG. 4 a lower face of a heating element 19 is arranged without contact with the outer face 9a of the top wall 9. Preferably, a vertical spacing between the outer face 9a and the lower face of the heating element 19 is between 0.8 times and 0.5 times the thickness of a strand of the heating element 19 and/or the heating element 19 is arranged by the distancing unit 21 at a spacing measured in the height direction from the outer face 9a of the adjacent wall, here the top wall 9, which is between 0.3 mm and 0.7 mm, in particular between 0.3 mm and 0.4 mm.

In FIG. 5 a plan view of the arrangement according to FIG. 3 and FIG. 4 is shown. By way of example, values of spacings and dimensions between individual strand portions of the heating element 19 and/or distancing elements and/or position securing elements are also illustrated here. In one exemplary embodiment, the heating element 19 has a strand diameter which is between 6 mm and 7 mm, in particular between 6 mm and 6.5 mm. In this exemplary embodiment, the position securing rod 28 furthest removed from the electrical connecting pieces 33 to 36 is not configured in a linear manner but angled. As can also be identified in this projection view which is shown in the x-z plane, in this exemplary embodiment the front position securing rod 39, when viewed in the depth direction, and the rear position securing rod 32 closest to the electrical connecting piece rods 33 to 36, extend further outwardly in the width direction than the further central position securing rods 30 and 31 in the example. Thus in one exemplary embodiment, the rod parts 26b, 29b, 22b, and 25b are also arranged offset further outwardly in the width direction than the further rod parts 23b, 24b, 27b and 28b. The hollow L-shaped strand portions 37h and 37g can also be identified here. They are shown edged by dashed lines.

In one exemplary embodiment, a perspective partial view of the muffle 8 with the arrangement according to FIG. 2 is shown in FIG. 6. The housing 2 is absent here. As can be identified here, a counter-coupling element 40 is integrally formed on an outer face 8a of the muffle 8. This counter-coupling element 40 here is a flange protruding from the outer face 8a. Viewed in the height direction, the flange is arranged offset downwardly relative to the top wall 9. In one exemplary embodiment, the flange can be arranged on an outer face of the side walls 12 and 13 of the muffle 8. Relative thereto, the flange protrudes to the side in the width direction. In a further exemplary embodiment, the flange can also be integrally formed on a top wall 9 which is formed in a trough-shaped manner.

As can be identified in FIG. 6, this counter-coupling element 40 extends as continuous projection or strip. It extends over substantially the entire depth of the side wall 12 or 13. It can be provided that this counter-coupling element 40 is also arranged on the outer face of the rear wall 11 of the muffle 8 and protrudes to the rear relative thereto. As can be identified here, the distancing unit 21 with the bent-back portions 22a, 24a, 26a, 29a, located further upwardly in the height direction, is positioned on an upper face 40a or a side of the counter-coupling element 40 facing the heating element 19. Moreover, the bent-back portions 23a, 24a, 27a, and 28a bear against a lower face 40b or a side of the counter-coupling element 40 remote from the heating element 19. Thus this plurality of bent-back portions 22a to 29a encompass this counter-coupling element 40 on both sides. In one exemplary embodiment, the counter-coupling element 40 is arranged between the bent-back portions 22a to 29b, in particular clamped therein.

As can also be identified in this context, in one exemplary embodiment the counter-coupling element 40, in particular, has continuous recesses 40c and 40d (FIG. 6) which are open, in particular, on the edge. The rod parts 23b and 24b are guided through these recesses from above, so that the bent-back portions 23a and 24a are arranged below the counter-coupling element 40. The rod parts 23b and 24b can be received precisely positioned through these recesses 40c and 40d which are open on the edge side. This improves the positionally secured locating of the distancing unit 21 on the muffle, in particular on the counter-coupling element 40. A clamped arrangement of the carrier and positioning rod on the opposing portions of the counter-coupling element 40 is also made possible in the width direction. Corresponding descriptions, as have been set forth in FIG. 6 relative to the distancing rods 22 to 25, also apply to the opposing distancing rods 26 to 29. As can be identified in FIG. 6, these bent-back portions 21a and 25a are positioned as positioning coupling parts on this upper face 40a of the counter-coupling element 40 facing the heating element 19. The further bent-back portions 23a and 24a bear from below as rear-engaging coupling parts, engaging behind the remote lower face 40b of the counter-coupling element 40.

A muffle front flange 41 is also shown in FIG. 6. This covers the intermediate space 16 on the front face. In the plan view in FIG. 5, it is also possible to identify these strand portions of the strand shape or the rod shape, which are shown in this exemplary embodiment and which are repeatedly bent or wound, of the heating element 19, in particular of the heating sub-elements 37 and 38.

The same can also be said of the further FIGS. 2, 3 and 6.

In FIG. 7 a plan view of the view in FIG. 6 is shown. It is also possible to identify here the further recesses 40e and 40f, which are open on the edge side, of the counter-coupling element 40 and through which the rod parts 27b and 28b of the distancing rods 27 and 28 are guided. In one exemplary embodiment in which the heating element 19 is formed from at least two heating sub-elements 37 and 38, these two heating sub-elements 37 and 38 extend with their larger dimensions and thus with their main surface in a common main extension surface. As can also be identified in FIG. 7 with a projection view, the heating element 19 is arranged inside the surface area of the top wall 9. This applies to all of the strand portions of the heating element 19 apart from the electrical connecting pieces 33 to 36.

The heating element 19 is thus located only in an intermediate space region 17 which is defined by the walls of the muffle 8 and the housing 2 which are arranged adjacent, and in particular parallel, to one another. In the example this is formed by the top wall 9 and the top wall 3.

If a heating element 19 has at least two such separate heating sub-elements 37 and 38, in particular wound into one another, in one exemplary embodiment at least one heating sub-element is configured with a maximum heat output of greater than or equal to 2 kW. Additionally or alternatively, it can also be provided that in a common operating mode the at least two heating sub-elements 37 and 38 have a total maximum heat output of greater than or equal to 3 kW.

In one exemplary embodiment, a maximum heat output of one of the two heating sub-elements 37, 38 is less than the maximum heat output of the other heating sub-element 37, 38. In one exemplary embodiment, the maximum heat output of the one heating sub-element with the greater maximum heat output is greater by at least 50%, in particular at least 60%, in particular at least a maximum of 90%, than the maximum heat output of the other heating sub-element 37, 38 which has the lower maximum heat output. In one exemplary embodiment, the maximum heat output of the heating sub-element 37, 38 with the lower maximum heat output is between 1.0 kW and 1.5 kW, in particular between 1.1 kW and 1.3 kW, in particular 1.2 kW. In one exemplary embodiment, the maximum heat output of the heating sub-element with the greater maximum heat output is between 2.0 kW and 2.5 kW, in particular between 2.1 kW and 2.3 kW.

In one exemplary embodiment, the maximum total heat output of the heating element 19 is between 3.0 kW and 4.0 kW, in particular between 3.2 kW and 3.6 kW, in particular between 3.3 kW and 3.5 kW.

In particular, in one exemplary embodiment, the heating sub-element which has the greater maximum heat output, which is the outer heating sub-element when viewed in the projection plane, in the exemplary embodiment is the first heating sub-element 37.

In one exemplary embodiment, the heating element 19 is configured with a surface density which, when viewed in the projection plane, is greater on the edge side than in the center.

In one exemplary embodiment, the maximum operating temperature of the heating element 19 is greater than 650° C., in particular greater than 700° C., in particular between 700° C. and 800° C.

In one exemplary embodiment, it is also provided that the cooking appliance 1 has a temperature sensor 42, as shown in FIG. 7. The temperature sensor 42 is arranged outside the cooking chamber 14. The temperature sensor 42 is configured for detecting the temperature of the heating element 19 and/or the wall adjacent to the heating element 19, here the top wall 9, of the muffle 8. In one exemplary embodiment, the temperature sensor 42 is arranged in the intermediate space region 17 and adjacent to and between the two heating sub-elements 37 and 38. In one exemplary embodiment, the temperature sensor 42 is arranged at the hottest point during operation. This relates, in particular, to the hottest point between the heating sub-elements 37 and 38. In particular, this relates to the hottest point of the wall, here the top wall 9, of the muffle 8, which is arranged adjacent to the heating element, here the heating element 19. In one exemplary embodiment, the temperature sensor 42 can be arranged directly on the outer face 9a. The temperature sensor can directly detect the temperature of this wall, here the top wall 9. In one exemplary embodiment, the temperature sensor 42 is arranged between the heating sub-elements 37 and 38, as shown in FIG. 7, in particular in a projection view. When considered in this projection view, in particular, the temperature sensor is preferably arranged at the same, or substantially the same, in particular the shortest, spacing from the adjacent heating sub-elements 37 and 38. The temperature sensor 42 can be a PT sensor, in particular a PT500 or a PT1000.

If the temperature sensor 42 is not arranged at the hottest point of the muffle 8, which is heated up by the heating element 19 adjacent to the top wall 9, it is preferably provided that a temperature offset value is generated. It can be provided that the maximum temperature value which the temperature sensor 42 can have, or might detect in order to avoid damage to the wall of the muffle, is lower than the value which can occur at the maximum hottest point of this wall of the muffle. For example, it can be provided that a maximum permitted temperature of 500° can occur at the hottest point of the wall adjacent to the heating element 19. If the temperature sensor 42 is not arranged at this hottest point of the top wall 9, a corresponding temperature offset value can be defined. This can be, for example, 20° C. lower. This is only an example, however, since such an offset value is dependent on where the temperature sensor 42 is arranged and which lower temperature can occur in this regard in comparison with the hottest point of the top wall 9 during the operation of the heating element 9.

It is also possible to provide a plurality of temperature sensors 42 which are arranged in the intermediate space region, here in the intermediate space region 17. The temperature sensors are preferably all arranged in each case between the two heating sub-elements 37 and 38, in particular viewed in the projection plane, substantially at the same spacing from the closest regions of the one heating sub-element 37 and the other heating sub-element 38.

In a heating element 19 which has at least two separate heating sub-elements 37 and 38, the cooking appliance 1 can have a first operating mode in which only one of the two heating sub-elements 37, for example the first heating sub-element, is activated. The second heating sub-element 38 is then deactivated. In a second operating mode only the second heating sub-element 38 can be activated. Then the first heating sub-element 37 is deactivated. In a third operating mode both heating sub-elements 37 and 38 can be activated at the same time. It is also possible that an individual maximum temperature threshold value for the wall at the hottest point, which should not be exceeded, is defined for each of these operating modes. The respective actual temperature is then measured by the at least one temperature sensor 42. When this temperature is reached or exceeded, in particular, the current actual heat output of the activated heating sub-element 37 and/or 38 is reduced in each case. Thus it is possible to avoid an overheating of the muffle 8, in particular the wall adjacent to the heating element 19, here the top wall 9. Since in one exemplary embodiment the heating sub-elements 37 and 38 have different maximum heat outputs, it is also advantageous in the respective operating modes to define different maximum temperature threshold values which, in particular, should not be exceeded. If both heating sub-elements 37 and 38 are activated and thus the third operating mode is active, the highest temperature threshold value can be predetermined in this regard. If only the heating sub-element with the lower maximum heat output, in comparison with the other heating sub-element, is activated, a lowest temperature threshold value can be predefined in this regard. In the other operating mode in which the heating sub-element with the greater maximum heat output, in comparison with the other heating sub-element, is activated alone, an average temperature threshold value can be defined or predetermined in this regard.

In one exemplary embodiment, a cooking appliance 1 can be implemented in which the heating element 19 is configured to be the same in terms of at least one electrical heating element parameter and/or in terms of at least one geometric heating element parameter. An electrical heating element parameter can be a maximum heat output of the entire heating element, for example. This means that the heating element 19 has the same maximum heat output as the heating element 20. It is also possible, when both heating elements 19, 20 have the same number of different separate heating sub-elements 37 and 38, that at least two heating sub-elements 20 and 19 of the heating elements have the same maximum heat output in each case. It is also possible that one heating sub-element of a heating element 19, 20 has the same maximum heat output as a further heating sub-element of the other heating element 19, 20. In a further exemplary embodiment, a further heating sub-element of a heating element 19, 20 can then also have the same maximum heat output as the further other heating sub-element of the other heating element 19, 20.

In one exemplary embodiment, a geometric heating element parameter can be a strand length of a heating element, for example. A further geometric heating element parameter can, for example, be a strand length of at least one heating sub-element of a plurality of heating sub-elements of a heating element. A further geometric heating element parameter can be, for example, the path of a strand shape of a heating element and/or the size of the heating element in one plane. In particular, in one exemplary embodiment a heating element 18 which is configured as a bottom-heat heating body can also have maximum heat outputs, as has been described above in the exemplary embodiments for the heating element 19 which is configured, in particular, as the top-heat and/or grill heating body.

In FIG. 8 a further exemplary embodiment of a heating element 19 is shown in a perspective view. In this exemplary embodiment, the electrical connecting pieces 33 to 36 are arranged asymmetrically to a central axis M. Otherwise, the shape of the at least two separate heating sub-elements 37 and 38 is according to the exemplary embodiment in FIG. 5. In FIG. 8, an alternative exemplary embodiment for the distancing unit 21 is also shown. This distancing unit is not connected in one piece to the position securing rods 39, 30, 31, 32. Rather, the distancing rods 22, 25, 26 and 29 are rods which are separate therefrom. In one exemplary embodiment, these distancing rods are represented by hooked-in bent-back portions, only one encompassing hook-in portion 26c thereof being shown for the sake of clarity in FIG. 8. Moreover, the descriptions as have already been set forth for the other exemplary embodiments apply to this exemplary embodiment.

In FIG. 9 an exemplary embodiment of a muffle of a cooking appliance 1 is shown in a simplified front view. In one exemplary embodiment, a thickness d2 of the side walls 12, 13 of the muffle 8 is different from a thickness d1 of the top wall 9 and/or from a thickness d3 of the bottom wall 10. Additionally or alternatively, the thickness d2 of the side walls 12 and 13 can also be different from the thickness of the rear wall 11.

In particular, the thickness d2 is smaller than the thickness d3 of the bottom wall 10 and/or smaller than the thickness d1 of the top wall 9.

In one exemplary embodiment, the thickness d2 is smaller by a value of between 0.2 mm and 0.5 mm, in particular between 0.25 mm and 0.35 mm, than the thickness d3 of the bottom wall 10 and/or correspondingly smaller than the thickness d1 of the top wall 9. In one exemplary embodiment, the thickness d2 is between 0.4 mm and 0.8 mm, in particular between 0.4 mm and 0.6 mm. In one exemplary embodiment, the thickness d3 of the bottom wall 10 is between 0.6 mm and 1.0 mm, in particular between 0.7 mm and 0.9 mm. In one exemplary embodiment, the thickness d1 of the top wall 9 is between 0.6 mm and 1.0 mm, in particular between 0.7 mm and 0.9 mm.

The muffle 8 is configured, in particular from metal, in particular steel.

In one exemplary embodiment, it can be provided that a base material, in particular steel, of the muffle 8 is provided at least in some regions on an outer face 8a remote from the cooking chamber 14 with an additional material which has a heat resistance of up to 550° C., in particular up to 530° C. This material can be applied as a coating to the outer face 8a of the muffle 8. This material can comprise, for example, enamel with a heat resistance of up to 550° C., in particular up to 530° C. In one exemplary embodiment, such an additional material can also be applied to an inner face 8b of the muffle 8 at least in some regions.

As can also be provided in the schematic view according to FIG. 9, in one exemplary embodiment an additional material can be applied at least in some regions to the outer face of the muffle 8. This additional material can be, for example, a coating 45. This coating 45 can comprise enamel. The coating can be made, in particular, entirely of enamel. In one exemplary embodiment, this coating 45 has on the outer face 8a of the muffle 8 a thickness of between 0.050 mm and 0.100 mm, in particular between 0.060 mm and 0.080 mm, in particular 0.070 mm. Moreover, a further coating 46 can be applied at least in some regions to an inner face 8b of the muffle 8. The coating is also applied here as additional material. The base material can be metal, in particular steel. In one exemplary embodiment, this coating 46 is formed with a layer thickness of between 0.100 mm and 0.200 mm, in particular between 0.140 mm and 0.160 mm, in particular 0.150 mm.

In FIG. 10 a partial region of an exemplary embodiment of a cooking appliance 1 is shown in a simplified vertical sectional view.

In one exemplary embodiment, at least one thermal shielding unit 43 of the cooking appliance 1 is arranged in the intermediate space 16, in particular in the intermediate space region 17. In one exemplary embodiment, the thermal shielding unit 43 is configured in a plate-like manner. The material of the thermal shielding unit 43 has, in particular, a temperature value as a melting point which is higher than the maximum operating temperature of the heating element 19 which is also arranged in this intermediate space region 17. In one exemplary embodiment, the thermal shielding unit 43 comprises rock wool. In one exemplary embodiment, the thermal shielding unit 43 is a mat made of fibrous material. In one exemplary embodiment, this thermal shielding unit 43 has a thickness a which is between 12 mm and 18 mm, in particular between 14 mm and 16 mm.

In one exemplary embodiment, the thermal shielding unit 43 is in direct contact with the heating element, here the heating element 19. In one exemplary embodiment, the thermal shielding unit 43 is arranged only on the side of the heating element 19 in the intermediate space region 17 which is remote from the top wall 9. In one exemplary embodiment, the heating element 19 is completely exposed toward the top wall 9. In a further exemplary embodiment, the thermal shielding unit 43 can also have or be a metal plate or a metal mesh.

In one exemplary embodiment, the cooking appliance 1 has a thermal insulating unit 44 which is separate from the thermal shielding unit 43. This thermal insulating unit is arranged in the intermediate space 16, in particular in the intermediate space partial region 17. In one exemplary embodiment, the thermal insulating unit is a mat made of fibrous material. In particular, it can comprise glass wool or be made of glass wool. In one exemplary embodiment, this thermal insulating unit 44 has a thickness b. The thickness b is greater than the thickness a. The thickness b can be between 20 mm and 30 mm, in particular between 24 mm and 26 mm. In particular, the material of the thermal insulating unit 44 is configured with a temperature value as a melting point which is lower than the maximum operating temperature of the heating element 19. In particular, the thermal insulating unit 44 is arranged only between the heating element 19 and the top wall 3 of the housing 2. This thermal insulating unit 44 is not arranged between the heating element 19 and the top wall 9 of the muffle 8. In particular, the thermal insulating unit 44 is arranged between the thermal shielding unit 43 and the top wall 3 of the housing 2.

In one exemplary embodiment, a thermal insulating unit 44, in particular a glass wool, can be arranged in the lower intermediate space region 18. The thermal insulating unit can have a thickness d of between 35 mm and 45 mm, in particular between 39 mm and 41 mm. This is the case, in particular, when no thermal shielding unit 43 is arranged in the lower intermediate space region 18.

In one exemplary embodiment, if a further heating element 20 is present, in particular as a bottom-heat and/or grill heating body, the corresponding arrangement with a thermal shielding unit 43 and/or a thermal insulating unit 44, as has been described in FIG. 9, can also be arranged in the intermediate space region 18. Here the preferably present thermal insulating unit 44 is located between the preferably present thermal shielding unit 43 and the bottom wall 4 of the housing 2.

Moreover, in one exemplary embodiment it can be identified in FIG. 10 that the top wall 9 is uneven. A dome-like bulging, in particular a bulging oriented upwardly, is formed here. In one exemplary embodiment, it can be provided that the heating element 19 is formed to be correspondingly curved or bulged. This bulging can be adapted to the bulging of the top wall 9. In one exemplary embodiment, as is shown in FIG. 11 in a partial view of the cooking appliance 1, the bulging is such that when viewed in the height direction a spacing c between the highest point of the bulging and the lowest point of a trough ceiling of the top wall 9, shown here, can be between 10 mm and 15 mm, in particular between 11 mm and 13 mm, for example 12 mm.

This spacing c is shown schematically in FIG. 11. Additionally or alternatively, a corresponding bulging can also be formed in the bottom wall 10. Additionally or alternatively, the bottom-heat heating body which is preferably present in the form of the heating element 20 can also be correspondingly bulged. However, this is a bulging which is outwardly bulged when viewed in the height direction.

In FIG. 12 a partial region of the heating element 19 is shown in an enlarged view. In one exemplary embodiment, a position of a temperature sensor 42 of the cooking appliance 1 is shown. This temperature sensor is formed here in a tubular manner, for example. Here the temperature sensor is arranged at the same or substantially the same spacings d and e from the closest points of the preferably present heating sub-elements 37 and 38 of the heating element 19. Preferably, the shape and configuration of the heating element 19 is such that the hottest point on the adjacent wall, here the top wall 9 of the muffle 8, occurs at the point shown in FIG. 12. The temperature detection can be carried out by the temperature sensor 42 practically at the hottest point of the top wall 9. The hottest point is defined by the heat profile of the heating element 19 during operation.

In FIG. 13 an exemplary embodiment of a muffle 8 of the cooking appliance 1 is shown in an exploded view. In this exemplary embodiment, the muffle 8 is of modular construction, in particular. This also means, in particular, that the muffle 8 is formed from a plurality of separate prefabricated modular components which are then connected together in a connecting method subsequent to their individual manufacture, in particular their respective final shape. In the exemplary embodiment shown here, the muffle 8 has the top wall 9 as a prefabricated separate component. In one exemplary embodiment, the bottom wall 10 is formed as a prefabricated separate component and as a modular component. Moreover, the preferably present front flange 41 is prefabricated and provided as a separate modular component of the muffle 8. Moreover, in one exemplary embodiment, a one-piece modular component is formed by the side walls 12 and 13 and the rear wall 11. Thus a U-shaped modular component or a U-shaped module is provided in this regard. As can be identified in FIG. 13, the top wall 9 has a trough shape. Additionally or alternatively, the bottom wall 10 can also have a trough shape. The trough shape of the top wall 9 is formed by a plate-like trough ceiling 47. Moreover, the top wall 9 has a trough collar 48 relative to its trough shape. This trough collar is arranged on a peripheral edge of the plate-shaped trough ceiling 47, in particular configured peripherally over at least three sides of the trough ceiling 47, which here is four-sided. It forms the side wall of the trough shape. As can also be identified, in one exemplary embodiment a flange 49 of the trough shape can also be provided. This flange 49 is a flange protruding from the trough collar 48. The flange is a projection which freely protrudes outwardly and thus laterally. This flange 49 is integrally formed on an edge of the trough collar 48 which is remote from the trough ceiling 47. In particular, in one exemplary embodiment this flange 49 is also the counter-coupling element 40 or it has this counter-coupling element 40, as has already been described above. In one exemplary embodiment, this trough-shaped top wall 9 preferably has the thickness d1 as has been described relative to FIG. 9.

In one exemplary embodiment, the bottom wall 10 has a trough bottom 50. Moreover, the bottom wall 10 has a trough collar 51. In one exemplary embodiment, a flange 52 can also be configured. This flange can correspondingly have a counter-coupling element 40 or be the counter-coupling element 40. The trough shape of the bottom wall 10 can be adapted to the trough shape of the top wall 9. In one exemplary embodiment, the top wall 9 can also be structurally the same as the bottom wall 10. In particular, the trough ceiling 47 is provided with a dome-like bulging, as has been described in FIG. 10 and FIG. 11. Additionally or alternatively, this trough floor 50 can also be correspondingly bulged. Moreover, it is also shown in FIG. 13 that in one exemplary embodiment the side walls 12 and/or 13 and/or the rear wall 11 can have embossed portions 53 and 54. As a result, individual reinforcement of the aforementioned walls can be achieved per se. This results in the entire muffle 8 being correspondingly more rigid in the assembled state.

In this context, the assembled state of the muffle 8 is shown in FIG. 14. As can also be identified here, in one exemplary embodiment the side walls 12 and 13 and the rear wall 14 are immersed in the respective trough shape of the two, in particular trough-shaped, components corresponding to the top wall 9 and the bottom wall 10. This means that this trough shape of the top wall 9 extends in the width direction and depth direction horizontally further outwardly than is provided by the position of the side walls 12 and 13 and the rear wall 11. Additionally or alternatively, the same can be provided with the bottom wall 10, as can be identified in FIG. 14. The stability of the muffle is also further increased by such a construction and corresponding interlocking. When viewed in the height direction, therefore, in one exemplary embodiment it is provided that the side walls 12 and/or 13 and/or the rear wall 11 are at least slightly immersed in the trough shape of the top wall 9 and/or the trough shape of the bottom wall 10.

Preferably unreleasable connections 55 are also configured between the individual module parts, namely the top wall 9 and the side walls 12, 13 and the rear wall 11. These unreleasable connections are, in particular, welded connections. Additionally or alternatively, further unreleasable connections, in particular welded connections 56, are configured between the side walls 12 and 13 and the rear wall 11 and the bottom wall 10. In one exemplary embodiment, the front flange 41 can also be connected by an unreleasable connection, in particular a welded connection 57, to the top wall 9, the bottom wall 10 and the side walls 12 and 13. In particular, the muffle 8 according to FIG. 13 and FIG. 14 can be formed with the thicknesses d1, d2 and d3 as has been described with reference to FIG. 9. Additionally, in one exemplary embodiment, the coating 45 and/or 46 can also be present.

All of the exemplary embodiments set forth herein can be in each case a constituent part of a cooking appliance, considered per se. It is also possible that a plurality of exemplary embodiments which are individually set forth herein can be combined and lead to a further exemplary embodiment which can also be regarded as disclosed. Thus, for example, the differently described muffles 8 in a cooking appliance 1 can be combined with correspondingly differently formed heating elements. In particular, on the other hand, the individually described heating elements 19, 20 can also be combined with different muffles to form a specific cooking appliance. In particular, all of the exemplary embodiments set forth herein can be implemented in a common exemplary embodiment of a cooking appliance.

In a further exemplary embodiment, a cooking appliance 1 can have a control apparatus 58 (FIG. 1). This control apparatus 58, shown symbolically in FIG. 1, can also be arranged differently in terms of location. It can be arranged on the cooking appliance 1, for example on the door 15, or separately from the door on a control panel of the cooking appliance 1 which is present, for example. The control apparatus 58 can be installed fixedly on the cooking appliance 1. It is also possible, however, that the control apparatus 58 is a separate component. The control apparatus can be a portable control apparatus 58 in this regard. For example, it can also be a communication terminal, such as for example a mobile wireless terminal. In this context, it is also possible to implement a system which has at least one cooking appliance 1 and such a control apparatus 58 which is separate therefrom and, in particular, portable.

In at least one operating mode of the cooking appliance 1, in which the heating element 19, which in particular is a top-heat and/or grill heating element, and a bottom-heat and/or grill heating element, which for example is implemented by the heating element 20, are activated by the control apparatus 58, the actual heat output of one of these two heating elements 19, 20 can be set differently from the actual heat output of the other heating element 19, 20. In this context, the control apparatus 58 can be connected to a preferably present control unit 59 (FIG. 1) of the cooking appliance 1. Thus signals relative to the control apparatus 58 can be transmitted to the control unit 59. The heating element 19 and/or the heating element 18 can be correspondingly operated by the control unit 59 which can also be a control and/or regulating unit.

In this context, it is also possible that the two heating elements 18 and 19 which are present, for example, have the same maximum heat output. However, they can also have different maximum heat outputs. Such a possibility of setting the actual heat output of at least one heating element 18, 19 differently from a maximum heat output results in many different possible combinations and setting options for providing individual combined heat outputs of both heating elements when they are both operated. Depending on the respective configuration of the actual heat output settings, cither more actual heat output can be provided from the bottom-heat and/or grill heating element than from the top-heat and/or grill heating element, or vice versa, more actual heat output can be provided from the top-heat and/or grill heating element than from the bottom-heat and/or grill heating element. In the exemplary embodiment, it is also possible that at least one of the actual heat outputs can be set by means of the control apparatus 58 as a percentage of the maximum heat output of this heating element 19, 20. Thus the actual heat output can be set in specific discrete percentage steps. In a further exemplary embodiment, it is also possible that the actual heat outputs of the two heating elements 19, 20 can be set in a percentage ratio to one another by the control apparatus. In the respective exemplary embodiments it is possible to implement both discrete values for this ratio and also a continuous setting. In this context, the control apparatus 58 can have corresponding control elements and/or touch-sensitive control panels. The control apparatus 58 can also have a display unit, in particular a display. The corresponding settings can be displayed there. In this context, however, the values and/or symbols of the heating elements 19, 20 can be shown. In one exemplary embodiment, in each case the set actual heat output and/or the ratio of the actual heat outputs and/or the percentage can be shown as values and/or symbols.

In one exemplary embodiment, it is also possible that when at least one of the two heating elements 19 and/or 20 is constructed from at least two separate heating sub-elements 37 and 38, the respective specific heating sub-element 37 and 38 can be individually selected by the control apparatus 58. Then the selected heating sub-elements 37 and 38 can be correspondingly activated. A further exemplary embodiment can also be proposed thereby, in which individual actual heat outputs of an entire heating element 19 or 20 can be selected in such a configuration. This is when either the one heating sub-element 37 and/or the other heating sub-element 38 or both heating sub-elements 37 and 38 are selected. In this context, in this exemplary embodiment this results in three different discrete actual heat outputs which can be set for one heating element.

### LIST OF REFERENCE CHARACTERS

1 Cooking appliance
2 Housing
3 Top wall
4 Bottom wall
5 Rear wall
6 Side wall
7 Side wall
8 Muffle
8a Outer face
8b Inner face
9 Top wall
10 Bottom wall
11 Rear wall
12 Side wall
13 Side wall
14 Cooking chamber
15 Door
16 Intermediate space
17 Intermediate space region
18 Intermediate space region
19 Heating element
20 Heating element
21 Distancing unit
22-29 Distancing rod
26c Hook-in portion
22a-29a Bent-back portion
22b-29b Rod part
30 Position securing rod
31 Position securing rod
32 Position securing rod
33-36 Connecting pieces
37 Heating sub-element
37a, b, c, d, e Strand portions
37f, g, h Strand portions
37e Connecting structure
38 Heating sub-element
38a, b H-shaped limb
38 Connecting limb
39 Position securing rod
40 Counter-coupling element
40a Upper face
40b Lower face
40c Recess
40d Recess
40e Recess
40f Recess
41 Muffle front flange
42 Door
43 Shielding unit
44 Insulating unit
45 Coating
46 Coating
47 Trough ceiling
48 Trough collar
49 Flange
50 Trough base
51 Trough collar
52 Flange
53 Embossed portions
54 Embossed portions
55 Connection
56 Welded connection
57 Welded connection
58 Control apparatus
59 Control unit
M Central axis
c Spacing
d Spacing
e Spacing
x Width direction
y Height direction
z Depth direction

1-13. (canceled)

14. A cooking appliance, comprising:
a housing;
a muffle arranged in the housing and having walls to define a cooking chamber of the cooking appliance;
a first heating element arranged outside the muffle in an intermediate space between the housing and the muffle, said first heating element arranged as a top-heat heating element in an upper intermediate space region formed between an upper one of the walls of the muffle and an upper outer wall of the housing in substantially parallel spaced-apart relation to the upper one of the walls of the muffle; and
a second heating element arranged outside the muffle in an intermediate space between the housing and the muffle, said second heating element arranged as a bottom-heat heating element in a lower intermediate space region which is formed between a lower one of the walls of the muffle and a lower outer wall of the housing in substantially parallel spaced-apart to the lower one of the walls of the muffle,
wherein the first heating element and the second heating element are designed of same configuration in terms of an electrical heating element parameter and/or in terms of a geometric heating element parameter.

15. The cooking appliance of claim 14, wherein the electrical heating element parameter of each of the first and second heating elements is a maximum heat output of an associated one of the first and second heating elements in its entirety and/or a maximum heat output of at least one heating sub-element of a plurality of heating sub-elements of the associated one of the first and second heating elements.

16. The cooking appliance of claim 14, wherein the geometric heating element parameter of each of the first and second heating elements is a strand length of an associated one of the first and second heating elements and/or a strand length of at least one heating sub-element of a plurality of heating sub-elements of the associated one of the first and second heating elements and/or a path of a strand shape of the associated one of the first and second heating elements and/or a size of the associated one of the first and second heating elements in a main extension surface.

17. The cooking appliance of claim 14, wherein the first heating element is the top-heat heating element and/or a grill heating element and/or the second heating element is the bottom-heat heating element and/or a grill heating element.

18. The cooking appliance of claim 14, wherein the first heating element has a maximum heat output which is between 3.0 kW and 4.0 kW, and/or the second heating element has a maximum heat output which is between 3.0 kW and 4.0 kW.

19. The cooking appliance of claim 14, wherein the first heating element has a maximum heat output which is between 3.2 kW and 3.6 kW, and/or the second heating element has a maximum heat output which is between 3.2 kW and 3.6 kW.

20. The cooking appliance of claim 18, wherein the maximum heat output of the first heating element and the maximum heat output of the second heating element are the same.

21. The cooking appliance of claim 14, wherein the first heating element comprises a first heating sub-element that is strand-like and repeatedly bent in a main extension surface, and a second heating sub-element that is strand-like and repeatedly bent in the main extension surface, wherein, when viewed in a projection plane, one of the first and second heating sub-elements is surrounded by the other one of the first and second heating sub-elements in a manner of a frame, wherein the first and second heating sub-elements are operable independently of one another in one operating mode of the first heating element, and operable jointly in a further operating mode of the first heating element, and
wherein the second heating element comprises a first heating sub-element that is strand-like and repeatedly bent in a main extension surface, and a second heating sub-element that is strand-like and repeatedly bent in the main extension surface, wherein, when viewed in a projection plane, one of the first and second heating sub-elements of the second heating element is surrounded by the other one of the first and second heating sub-elements of the second heating element, wherein the first and second heating sub-elements are operable independently of one another in one operating mode of the second heating element, and operable jointly in a further operating mode of the second heating element.

22. The cooking appliance of claim 21, wherein at least one of the first and second heating sub-elements of each of the first and second heating elements has a maximum heat output of greater than or equal to 2 kW, and/or wherein the first and second heating sub-elements of each of the first and second heating elements have a total maximum heat output of greater than or equal to 3 kW in a common operating mode.

23. The cooking appliance of claim 21, wherein the maximum heat output of one of the first and second heating sub-elements of the corresponding one of the first and second heating elements is less than the maximum heat output of the other one of the first and second heating sub-elements of the corresponding one of the first and second heating elements.

24. The cooking appliance of claim 21, wherein the maximum heat output of one of the first and second heating sub-elements of each of the first and second heating elements is greater by at least 50% than the maximum heat output of the other one of the first and second heating elements of each of the first and second heating elements.

25. The cooking appliance of claim 21, wherein the maximum heat output of one of the first and second heating sub-elements of each of the first and second heating elements is greater by at least 60% than the maximum heat output of the other one of the first and second heating elements of each of the first and second heating elements.

26. The cooking appliance of claim 21, wherein the maximum heat output of one of the first and second heating sub-elements of each of the first and second heating elements is greater by a maximum of 90% than the maximum heat output of the other one of the first and second heating elements of each of the first and second heating elements.

27. The cooking appliance of claim 24, wherein the maximum heat output of the other one of the first and second heating elements of each of the first and second heating elements is between 1.0 kW and 1.5 kW, and/or the maximum heat output of the one of the first and second heating elements of each of the first and second heating elements is between 2.0 kW and 2.5 kW.

28. The cooking appliance of claim 24, wherein the maximum heat output of the other one of the first and second heating elements of each of the first and second heating elements is between 1.1 kW and 1.3 kW, and/or the maximum heat output of the one of the first and second heating elements of each of the first and second heating elements is between 2.1 kW and 2.3 kW.

29. The cooking appliance of claim 21, wherein, when viewed in the projection plane, the first heating sub-element of each of the first and second heating elements surrounds the second heating sub-element of the first and second heating elements, respectively, with the first heating sub-element having a maximum heat output which is greater than a maximum heat output of the second heating sub-element.

30. The cooking appliance of claim 14, wherein the first and second heating elements are resistance heating elements.
